(19) United States
(12) Patent Application Publication
(10) Pub. No.: US 2026/0221118 A1
(43) Pub. Date: Jul. 30, 2026

(54) INTERACTIVE DISPLAY PANEL WITH PROXIMITY-SENSING OPTICAL CELLS

(71) Applicant: Voria Labs LLC, Ashland, OR (US)

(72) Inventor: Robert Sun Quattlebaum, Ashland, OR (US)

(21) Appl. No.: 19/459,875

(22) Filed: Jan. 26, 2026

Related U.S. Application Data
(60) Provisional application No. 63/749,438, filed on Jan. 24, 2025.

(51) Int. Cl. G09G 5/00; G06F 3/01; G06F 3/03

(52) U.S. Cl. CPC G09G 5/006; G06F 3/011; G06F 3/0304; G09G 2354/00; G09G 2360/14

(57) ABSTRACT

Techniques for optical sensing and emission are disclosed. An optical sensing apparatus includes a plurality of optical cells configured to detect the presence of an object proximate to the apparatus by detecting reflected components of modulated invisible light emitted by one or more cells and received by other cells. The cells are synchronized to a timing reference and calibrated to determine spatial characteristics of objects proximate to the apparatus. Based on the detected spatial characteristics, the apparatus generates control signals to emit visible light in a manner that varies according to object proximity. The apparatus supports coordinated operation across multiple cells and may dynamically adjust sensing and emission behavior based on calibration data and operating conditions.

### CROSS-REFERENCE TO RELATED APPLICATION

This application claims the benefit of U.S. Provisional Patent Application 63/749,438, filed January 24, 2025, which is hereby incorporated by reference.

### TECHNICAL FIELD

The present disclosure generally relates to display panels, optical sensors, and lighting fixtures, including light emitters, light detectors, diffusers, and related systems.

### BACKGROUND

Conventional lighting fixtures are traditionally designed to provide illumination for purposes such as general lighting, ambient lighting, task lighting, or decorative lighting. Traditional lighting fixtures typically emit visible light of a fixed color, intensity, or pattern. While some modern lighting systems allow for manual adjustment of brightness or color, such adjustments are often preprogrammed or made manually using a controller such as a dial. Lighting is also sometimes used for aesthetic purposes, but aesthetic lighting is generally still limited by static or preprogrammed lighting effects. Lighting fixtures sometimes deploy optical diffusers to improve visual uniformity and reduce glare.

Non-visible light emitters and sensors, such as infrared light sources and photodetectors, have been employed in various applications. For example, automatic doors detect the presence of people using non-visible light emitters and sensors. Traditional proximity sensors typically operate as devices that emit light to infer the presence of nearby objects based on the nearby objects obstructing or reflecting the light. Such sensors are typically optimized for simple on/off detection or coarse distance measurement. In many cases, such sensors are sensitive to ambient light interference or require unobstructed optical paths to function reliably. Traditional proximity sensors rely on light being able to reflect directly off of an object of interest without obstruction.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The implementations are illustrated by way of example and not by way of limitation in the figures of the accompanying drawings. It should be noted that references to “an” or “one” implementation in this disclosure are not necessarily to the same implementation, and they mean at least one. In the drawings, in accordance with one or more implementations:

FIG. 1A illustrates a perspective diagram of an implementation of an interactive display panel;

FIG. 1B illustrates a side view diagram of the interactive display panel;

FIG. 1C illustrates a diagram of synchronization operations for the interactive display panel;

FIG. 1D illustrates a diagram of calibration operations for the interactive display panel;

FIG. 2 illustrates an interactive display panel system;

FIG. 3 illustrates a set of operations for optical emitting, detecting, and illumination;

FIG. 4 illustrates an example interactive display panel;

FIG. 5 illustrates an operational sequence of the interactive display panel;

FIG. 6 illustrates a proximity-sensing optical cell of the interactive display panel;

FIG. 7 illustrates an example implementation of proximity-sensing optical cells;

FIG. 8 illustrates a communication flow for a set of proximity-sensing optical cells;

FIG. 9 illustrates a table of uncalibrated light detection data;

FIG. 10 illustrates a table of lower-bound light detection data;

FIG. 11 illustrates a table of upper-bound light detection data;

FIG. 12 illustrates a table of neighboring optical cell data;

FIG. 13 illustrates a table of calibrated light proximity data; and

FIG. 14 illustrates a block diagram of a computing system.

### DETAILED DESCRIPTION

The Figures(FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. Wherever practicable, similar or like reference numbers may be used in the figures and may indicate similar or like functionality.

### 1. General Overview

One or more implementations include an optical sensor apparatus that senses presence or proximity of an object in the environment of the apparatus. One or more implementations include a display panel with an output effect that changes dynamically to adjust an output effect of one or more optical cells of the panel based on the presence or proximity of an object. In one or more embodiments, one or more optical cells include diffusers, emitters, and/or detectors. During a scan operation, the emitters emit light, through the diffusers, that is detected by the detectors. The scan process adjusts for ambient light dynamically while scanning the environment for present objects. The cell(s) are calibrated so that the dynamic effects output by the cell(s) are smooth, uniform, and aesthetically pleasing. The calibration accounts for environmental differences and the topology of the cells of the panel that could otherwise cause inconsistencies and/or non-uniformity in the effects produced by the panel.

In general, lighting structures are traditionally static in brightness and monochromatic. In some cases, lighting effects can be manually adjusted using dimmers or remote controls. By using invisible light to detect the presence of an object, implementations described herein provide a lighting display that is interactive and that changes dynamically based on interaction with the panel. Implementations account for the presence of ambient light and/or normalize output signals based on measurements of the amount of reflected light received at individual cells and/or groups of cells during scan operations. The cells are calibrated by using high level and low level measurements taken during a scan operation occurring while the display panel is in a particular environment. Calibrating the interactive display panel facilitates responsiveness to objects near the display panel in the environment.

One or more implementations include an optical sensor apparatus that includes at least a first cell and a second cell. The first cell includes a first optical diffuser; an emitter configured to emit, through the first optical diffuser, a modulated invisible light signal; and a first controller configured to cause the emitter to emit the modulated invisible light signal according to a temporal modulation pattern. The second cell includes a second optical diffuser; a detector configured to receive, through the second optical diffuser, a reflected component of the modulated invisible light signal; and a second controller configured to perform an assessment of a presence of an object at least in part by identifying the reflected component as corresponding to the modulated invisible light signal by correlating the reflected component with the temporal modulation pattern and selectively generate an output signal based on the assessment.

One or more implementations include an interactive display system that includes a frame, a power supply, an interface, and a display panel. he interface may include at least one of a power toggle, a brightness control, or an operation mode selector. The display panel is supported by the frame and operatively coupled to the power supply and to the interface. The display panel includes at least a first cell and a second cell. The first cell includes a first optical diffuser; an emitter configured to emit, through the first optical diffuser, a modulated invisible light signal; and a first controller configured to cause the emitter to emit the modulated invisible light signal according to a temporal modulation pattern. The second cell includes a second optical diffuser; a detector configured to receive, through the second optical diffuser, a reflected component of the modulated invisible light signal; and a second controller configured to perform an assessment of a presence of an object at least in part by identifying the reflected component as corresponding to the modulated invisible light signal by correlating the reflected component with the temporal modulation pattern and selectively generate an output signal based on the assessment.

One or more embodiments include a method for optically sensing a reflected component of invisible light. The method includes causing an emitter to emit a modulated invisible light signal according to a temporal modulation pattern; emitting, by the emitter, through a first optical diffuser, the modulated invisible light signal; receiving, by a detector of a second cell, through a second optical diffuser, a reflected component of the modulated invisible light signal; performing an assessment of a presence of an object at least in part by identifying the reflected component as corresponding to the modulated invisible light signal by correlating the reflected component with the temporal modulation pattern; and selectively generating an output signal based on the assessment.

Various implementations include methods including one or more operations described herein. Implementations include a computer-readable medium containing instructions that, when executed using a processor, perform one or more operations of the methods. One or more implementations include a system including a processor configured to perform one or more operations of the methods.

### Example Implementation

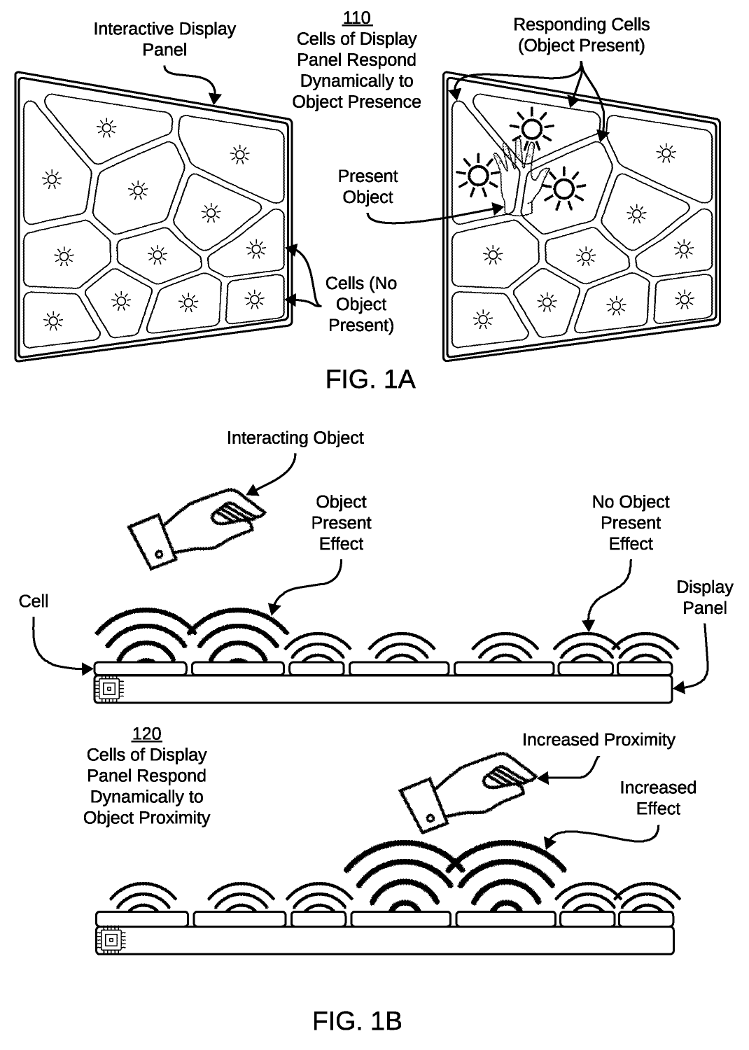

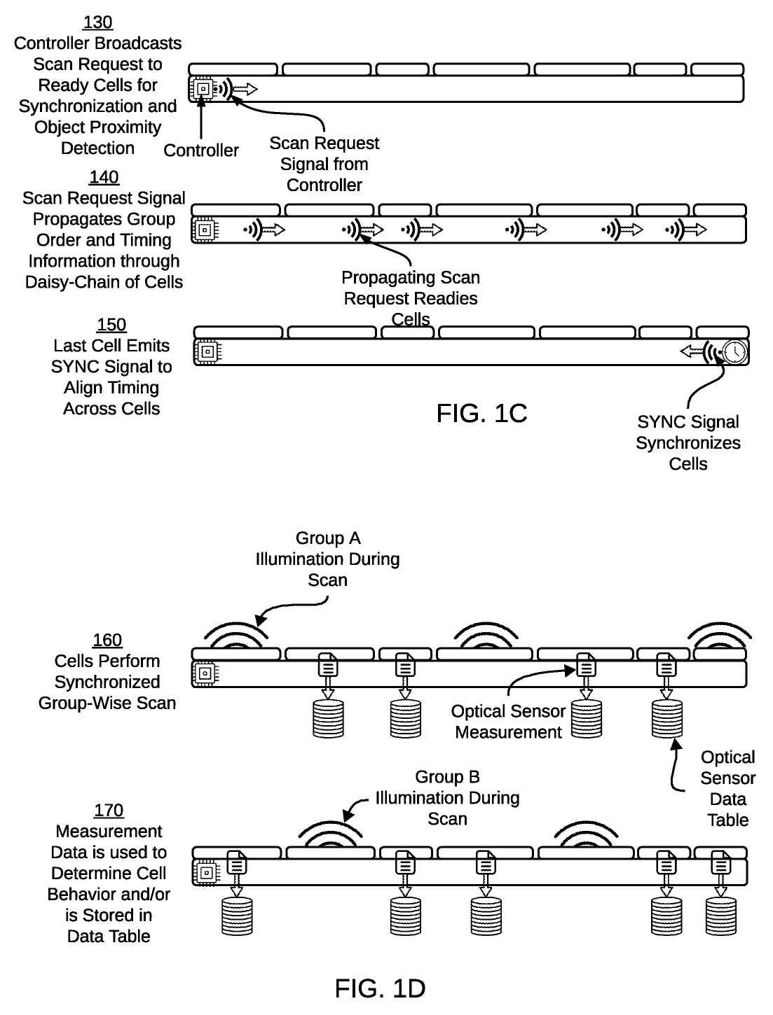

FIG. 1A illustrates a perspective diagram of an implementation of an interactive display panel, described herein. As shown in FIG. 1A, and by reference number 110, cells of the display panel respond to object presence. In this example, cells of the display panel respond to object presence by selectively emitting an effect based on whether an object is detected in the external environment of the cells. In some implementations, the effect comprises visible light emitted through optical diffusers of the cells, and the emitted light varies according to detection of the object. For example, in some implementations, a cell with no object within a threshold distance of the cell does not emit an effect, emits a lesser effect, or emits a first effect, whereas another cell with an object present or within a threshold distance emits an effect, emits a greater effect, or emits a second effect different from the first effect. For example, the cells of the interactive display emit an effect that changes based on the presence and/or proximity of an object relative to the cells. The result is a satisfying interactive aesthetic experience for a person interacting with the display panel.

FIG. 1B illustrates a side view diagram of the interactive display panel, described herein. As shown in FIG. 1B, and by reference number 120, cells of the display panel respond dynamically to object proximity. For example, the cells of the display panel respond dynamically to object proximity, such that characteristics of an emitted effect change based on a degree of proximity of the object relative to one or more cells. For example, cells closer to the object may emit light at a higher intensity or different color than cells farther from the object.

In various implementations, one or more cells of the display panel emit a first effect, such as light or sound, when no object is present within a configurable distance from one or more cells. One or more other cells of the display panel emit a second effect when an object is present within the configurable distance from the other cell(s). In some implementations, the effect(s) emitted by the cell(s) changes dynamically, such as by changing brightness, intensity, volume, or color, according to a degree of proximity of one or more objects. For example, as a person interacts with the display panel by waving their hand in front of the display panel, the cells of the display panel closest to the person’s hand will respond dynamically with a change in color or brightness of light emitted from the cells. The interactive display panel may have several different normal operation modes in which the cells have different behaviors and/or effects that are based on the presence or proximity of an object. For example, the interactive display panel may emit different kinds of light and/or sound based on the presence or proximity of an object.

FIG. 1C illustrates a diagram of synchronization operations for the interactive display panel. As shown in FIG. 1C, and by reference number 130, a controller broadcasts a scan request to ready cells for synchronization and object proximity detection. In some instances, the object proximity detection includes taking measurements of light entering the detectors of the cells that are used for normalization during calibration. In other instances, the object proximity detection includes taking measurements of light entering the detectors of the cells that are used to determine whether an object is present to determine the behavior of the cells during operation of the display panel. In this example, the scan request initiates a scan-ready state at the cells and conveys information, such as group order and/or modulation timing, used to coordinate subsequent group-wise illumination and sensing operations.

As shown in FIG. 1C, and by reference number 140, the scan request signal propagates group order through a daisy-chain of cells. In some implementations, the cells forward the scan request downstream to prepare cells for synchronized illumination and detection according to a defined sequence of groups.

As shown in FIG. 1C, and by reference number 150, the last cell emits a SYNC signal to align timing across cells. The SYNC signal establishes a shared temporal reference that synchronizes modulation timing for emitters and sampling timing for detectors to a common timing reference, thereby aligning emission and detection intervals across the cells of the display panel. In some implementations, a main control board emits a SYNC signal after a predetermined or calculated delay. The delay is determined such that the main control board emits the SYNC signal once (at the same time as or after) the last cell in the daisy-chain has received the scan command.

FIG. 1D illustrates a diagram of calibration operations for the interactive display panel. As shown in FIG. 1D, and by reference number 160, cells perform synchronized group-wise scan. During normal operation, the group-wise scan measures light received at detectors of the cells and adjusts the outputs of the cells based on the values of the measured light. During scan operations, different groups of cells sequentially emit modulated invisible light in series while detectors of the cells measure reflected components of the emitted light. For example, one or more cells measure different reflected components received at one or more detectors of the cell(s) for the different groups. The values of detected light used to determine the output behavior (e.g., color, brightness, etc.) of the cells during normal operation are adjusted according to calibration values determined by a calibration scan. During calibration, the display panel also performs a scan whereby different groups of cells sequentially emit modulated invisible light in series while detectors of the cells measure reflected components of the emitted light. However, the measurements of the reflected components during calibration are stored and used to determine calibration parameter values rather than used to determine cell output behavior directly.

As shown in FIG. 1D, and by reference number 170, measurement data is used to determine cell behavior and/or is stored in a data table. Detectors located in the cells measure amounts of light received at the detectors. During normal operation, the amounts of light are used to determine cell behavior. During calibration, the amounts of light are stored and used in calculations to determine calibration weights that are applied to the measurements of light received at the detectors during normal operation to improve the accuracy, responsiveness, and sensitivity of object proximity detection during normal operation.

The cells include detectors that measure amounts of received light. In some implementations, the detectors are photodiodes that convert detected signals to linearized values using an analog-to-digital converter. In other implementations, a phototransistor may be deployed to detect light signals. In such implementations, a linearization step may be included to linearize non-linear readings from the phototransistor. One or more implementations store measurements during calibration that include minimum and maximum observed signal values for individual cells. The minimum and maximum values are subsequently used to derive calibration coefficients that are applied to optical sensor data obtained during normal operation and/or later scan operations.

In some implementations, the display panel includes multiple cell groups having multiple cells that are assigned to the groups such that the cells within a group are separated from other cells in the same groups. During group calibration operations, the cells emit signals by group that facilitate calibration of the individual cells and/or the cell groups. For example, the cells of the display panel measure amounts of light, which may be any type of visible or non-visible light, received at detectors of the cells in a group when none of the cells of that group are emitting a calibration signal. For example, the cells of the display panel that are not members of a first group of cells, “Group A,” measure different amounts of light received at detectors of the cells while the first group of cells, “Group A,” is emitting a calibration signal. Subsequently, the cells of the display panel not in a second group of cells, “Group B,” measure different amounts of light received at detectors of the cells while the second group of cells, “Group B,” is emitting a calibration signal.

The cells of the display panel measure different amounts of light received at detectors of the cells while the cells of any number of different groups emit a calibration signal. The cells record a set of measurements when no objects are near the display panel in the environment. The cells also record a set of measurements as an object is passed across the face of the display panel, near the cells. Separate measurements for both sets are taken for cells for different groups during a serial group-wise illumination of the panel. In general, the separate sets of measurements provide “low” and “high” readings for the cells. The different measurements are used to synchronize, normalize, and/or calibrate the cells.

### 2. Optical Sensor Apparatus System

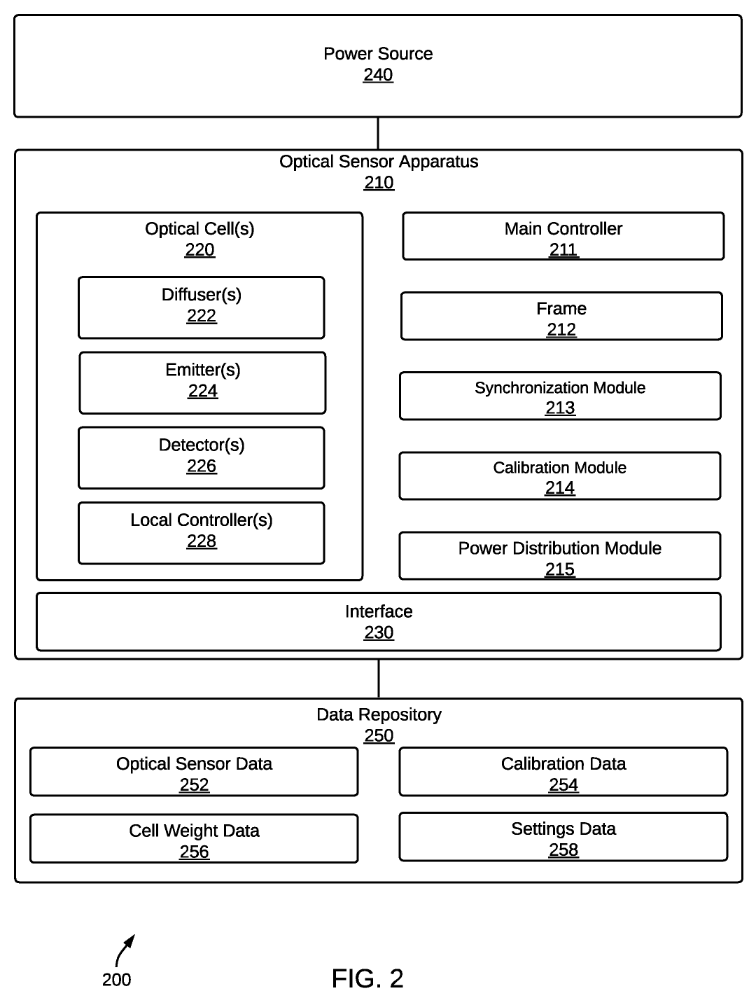

FIG. 2 illustrates an interactive display panel system 200, in accordance with one or more embodiments. In FIG. 2 an optical sensor apparatus 210 is coupled to a power source 240 and a data repository 250.

As shown in the example of FIG. 2, the optical sensor apparatus 210 includes a main controller 211, a frame 212, a synchronization module 213, a calibration module 214, a power distribution module 215, one or more optical cells 220, and an interface 230.

In the example, the main controller 211 is a centralized electronic control unit positioned on a main control board that coordinates operation of an optical object-detection panel composed of multiple cells. The main controller 211 facilitates responsive behavior of the cells to proximity of objects detected by the cells. For example, the main controller 211 controls output devices located at the cells that emit different patterns of light that respond to objects being detected near the panel.

The panel includes multiple cells that are arranged along a face of the panel and detect proximity of objects in front of the face of the panel. For example, the cells determine the three-dimensional location of the object by determining occlusion over the two-dimensional face of the panel and by determining distance of the object from the panel along an axis perpendicular to the two-dimensional face. The main controller 211 includes one or more processors, associated memory, and/or communication interfaces configured to issue scan requests, receive measurement data from downstream cells, and/or assemble a global data table representing measured invisible light (e.g., infrared) signal values by cell and by group. The main controller 211 uses the measured invisible light signal values for the cells to determine the brightness or color of visible light emitted by the cells during normal operation.

The main controller 211 further maintains calibration data, including minimum and maximum observed signal levels, linear scaling coefficients, and neighbor-based weighting coefficients, which are applied to raw measurements to generate calibrated and normalized occlusion values. The main controller 211 is physically connected to a first cell in a daisy-chain arrangement via a downstream communication port and interfaces with reset and synchronization signaling lines distributed across the panel.

The frame 212 is a structural assembly that supports and spatially arranges the one or more cells 220, forming an optical object-detection panel. The frame 212 defines fixed relative positions of the cells in a two-dimensional layout, including non-uniform arrangements such as Voronoi-style tessellations. The frame 212 provides mechanical support for optical components including diffusers, lenses, infrared emitters, and photodetectors, while also accommodating routing paths for power, communication, reset, and synchronization conductors. In the example, the frame 212 forms part of an interactive light structure that may be wall-mounted, integrated into furniture, or embedded into architectural surfaces, while maintaining alignment and spacing between adjacent cells required for inter-cell optical measurements.

The synchronization module 213 is a control module associated with the managing timing alignment across the one or more cells 220. For example, the synchronization module 213 uses synchronization signals to temporally align one or more cells 220 using a synchronization signal. In some implementations, the synchronization module 213 distributes synchronization signals to cells 220 to establish a shared temporal reference during scan operations. In some implementations, the synchronization signal is asserted at defined points during a scan, including prior to initiation of group illumination intervals, to align internal timing used for infrared emission and sampling. In some implementations, the synchronization module 213 also facilitates re-synchronization during scanning to account for clock drift among local controllers so that modulation and sampling remain temporally aligned across cells 220.

The calibration module 214 is a control module associated with the main controller 211 that manages calibration of optical sensor data collected from the cells. The calibration module 214 maintains data structures that record lowest and highest observed infrared signal values for individual cells. In some implementations, the calibration module 214 uses the recorded lowest and highest observed infrared signal values to compute calibration coefficients. For example, the calibration module 214 applies linear scaling and/or offset transforms to raw measurements to produce calibrated sensor values. The calibration module 214 derives weighting coefficients from information describing cell neighbor relationships and relative cell contributions. The calibration module 214 applies the weighting coefficients to the calibrated sensor values to improve the accuracy of proximity and/or occlusion measurements across the panel.

The power distribution module 215 is an electrical subsystem that supplies operating power to the main controller 211 and the plurality of cells mounted within the frame 212. The power distribution module 215 includes voltage regulation components, distribution conductors, and/or protection circuitry that deliver appropriate supply levels to infrared emitters, photodetectors, microcontrollers, and/or communication interfaces. The power distribution module 215 is physically integrated with the panel assembly to provide consistent power delivery along daisy-chain interconnections between the main controller 211 and the one or more cells 220. The power distribution module 215 supports simultaneous illumination, sensing, and communication activities, during scan and normal operations.

In various implementations, the power distribution module 215 supplies operating power to emitter(s) 224, detector(s) 226, and/or control circuitry of the cell(s) 220 and may operate in coordination with the local controller(s) 228 to selectively enable or disable power delivery to individual components or groups of components. In some implementations, control authority over emission, detection, and participation in scan operations is distributed between main controller 211 and local controller(s) 228, such that local controller(s) 228 execute group assignments, modulation schedules, and detection operations responsive to commands or timing references provided by the main controller 211. In some implementations, local controller(s) 228 may independently gate power to emitter(s) 224 or detector(s) 226 based on group membership, operational state, or fault conditions to facilitate scalable operation, reduced power consumption, and/or continued operation in the presence of partial power failures.

In the example shown, the one or more optical cells 220 include one or more diffusers 222, one or more emitters 224, one or more detectors 226, and one or more local controllers 228. In one or more implementations, the optical cell(s) 220 are arranged planarly across a face of the optical sensor apparatus 210.

The diffuser(s) 222 are optical components positioned on or in front of individual cells and arranged to diffuse both visible light emitted for user-facing illumination and invisible infrared light used for object detection. The diffuser(s) 222 are formed from light-scattering materials configured to spread incident light over a broader area rather than allowing a focused beam. For example, the diffuser(s) 222 are disposed in front of infrared light emitting diodes (LEDs) and infrared photodetectors. In some implementations, a diffuser 222 is combined with a lens into a single optical element. In some implementations, additional optical layers, including brightness-enhancing films or attenuating layers are stacked with the diffuser(s) 222 as part of the cell’s optical assembly. The presence of the diffuser(s) 222 contributes to uniform visual appearance of the panel. However, use of diffusers 222 presents challenges for infrared proximity detection that are solved by aspects of optical sensor apparatus 210 described herein.

The emitter(s) 224 are visible and/or non-visible light emitting devices mounted within individual cells and configured to emit light used for illumination, proximity detection, and object detection. For example, emitter(s) 224 are implemented as infrared light-emitting diodes (LEDs) that transmit modulated infrared light during scan operations. In some implementations, an emitter includes an infrared blaster, which is a series of infrared LEDs.

In the described implementation, groups of cells illuminate concurrently, with the emitter(s) 224 in an active group transmitting identical temporally modulated codes, such as Manchester-encoded pseudo-random bit sequences. In some implementations, the temporally modulated codes include emitter-specific identifiers in addition to or instead of cell group identifiers. In some implementations, the modulation frequencies are on the order of 100 kHz. The emitter(s) 224 are controlled by one or more associated local controllers 228 to selectively enable or disable emission according to group assignments and synchronization signals during scanning. In some implementations, the emitter(s) 224 are controlled by one or more associated local controllers 228 to programmatically emit visible light having a particular brightness and/or color according to an operation mode and presence, absence, and/or proximity of an object in the environment which the optical sensor apparatus 210 faces.

The detector(s) 226 are infrared photodetectors positioned within individual cells and oriented to receive infrared light reflected from objects and from adjacent cells. The detector(s) 226 are implemented as photodiodes configured to generate electrical signals corresponding to incident infrared light intensity. For example, a photodiode generates a small electric current in response to light striking the photodiode. The electric current is proportional to the amount of light (e.g., radiant flux, or watts) hitting the photodiode. This small current is amplified and converted to a voltage via a transimpedance amplifier. The voltage output of the transimpedance amplifier is then read by an analog-to-digital converter (ADC) to generate a digital signal representing the amount of light received at the photodiode.

During scan operations, the detector(s) 226 measure reflected infrared light over defined time intervals while one or more groups of emitter(s) 224 are active. The detector(s) 226 produce measurement data that is accumulated based on known on-and-off states of the emitter(s) 224. The measurement data facilitates separation of reflected infrared signals from ambient infrared background. The resulting measurements based on the reflected components of the separated signals are forwarded to local controller(s) 228 and/or the main controller 211 for aggregation and processing.

The local controller(s) 228 are microcontroller units integrated into individual cells and responsible for managing cell-level illumination, emission, sensing, and communication. The local controller(s) 228 control operation of the emitter(s) 224, sample signals from the detector(s) 226, and participate in synchronized scan operations coordinated by the main controller. The local controller(s) 228 include communication interfaces configured for performing serial communication in a daisy-chain topology and for receiving asserted commands from the main controller 211. The daisy-chain topology enables forwarding of commands, synchronization information, and measurement data between upstream and downstream cells. Receiving asserted commands from the main controller 211 allows the commands to be received by multiple local controllers 228 simultaneously or nearly simultaneously.

During initialization, the local controller(s) 228 receive unique sequential identifiers, group assignments, and/or modulation timing information. During scanning, the local controller(s) 228 cause groups of cells to emit invisible light sequentially. The local controller(s) 228 at the cells then collect measurements of reflected components of the invisible light and/or transmit the collected measurements for inclusion in a data table of cell-wise measurement values. Collected measurements from scanning are used to determine normalization values during calibration. Collected measurements from scanning are also used to determine the behavior of cells during normal operation.

The interface 230 refers to hardware and/or software configured to facilitate communications between a user and the optical sensor apparatus 210. For example, the interface 230 may include components such as a power toggle, brightness adjuster (e.g., a “dimmer”), an operation mode selector, such as a button or buttons, and/or the like.

In one or more implementations, interface 230 includes a universal serial bus (USB) port and software that renders user interface elements and receives input via user interface elements. The USB port may be used to connect to external hardware and/or software that may be used to configure the main controller 211. In some implementations, the interface 230 includes a Wi-Fi, Bluetooth, or other wireless communication component that may be used to configure parameters and/or update firmware for the apparatus 210.

Examples of interfaces include a graphical user interface (GUI), a command line interface (CLI), a haptic interface, and a voice command interface. These types of interfaces may be integrated directly via the display panel system 200 or may be accessible via a connected device (such as a mobile device or personal computer) executing an application with various user interface elements. Examples of user interface elements include checkboxes, radio buttons, dropdown lists, list boxes, buttons, toggles, text fields, date and time selectors, command lines, sliders, pages, and forms.

The power source 240 is an electrical supply configured to provide operating power to the main controller, the local controllers, and associated optical and communication components of the panel. The power source 240 is implemented as an external or integrated supply that delivers one or more regulated voltage levels suitable for infrared emitters, photodetectors, microcontrollers, and communication circuitry. In the described example, the power source 240 supplies power that is distributed across the panel to support synchronized scan operations, group-based illumination, data acquisition, and communication between cells and the main controller.

The data repository 250 is a storage structure accessible by the main controller and configured to store data generated during initialization, scanning, calibration, and interpretation of optical measurements. In the example shown in FIG. 2, the data repository 250 includes optical sensor data 252, calibration data 254, cell weight data 256, and settings data 258. The data repository 250 is implemented using one or more memory devices, such as non-volatile memory for persistent data and/or volatile memory for temporary scan results and may be organized to support table-based representations of measurements indexed by cell and by group.

The optical sensor data 252 includes measured infrared signal values collected during scan operations for combinations of cells and cell groups. The optical sensor data 252 is populated when cells measure reflected infrared light while one or more groups of emitter(s) 224 are active, and the resulting values are reported upstream to the main controller. In the example, the optical sensor data 252 is arranged in a table in which rows correspond to individual cells and columns correspond to cell groups, with entries representing accumulated or averaged infrared signal measurements for a given cell-group pairing.

The calibration data 254 includes values used to normalize and scale optical sensor measurements across cells. The calibration data 254 includes recorded minimum and maximum signal values observed for individual cells over time and linear transformation coefficients derived from those minimum and maximum signal values. The calibration data 254 supports shifting and scaling of raw optical sensor data to produce calibrated values that result in improved sensitivity and consistency across the panel. Calibration data 254 may be stored and reused across multiple sessions of scan operations.

The cell weight data 256 includes weighting coefficients associated with individual cells that compensate for non-uniform sensitivity arising from differences in cell geometry and neighborhood relationships. The cell weight data 256 is derived from information describing neighboring cells, such as shared edge lengths by group, and includes normalized inverse weights computed from summed neighbor contributions. The cell weight data 256 is applied to calibrated optical sensor values to generate adjusted occlusion or proximity values that exhibit improved uniformity across the panel.

The settings data 258 includes configuration parameters governing operation of the optical detection system. The settings data 258 includes values defining scan behavior, group assignments, modulation parameters, synchronization timing, calibration usage, and/or operating mode behaviors. The settings data 258 includes values for configurable parameters that control interpretation of sensor data and their effect on attributes, such as intensity or color, of illumination produced by the optical cell(s) 220.

In one or more implementations, the data repository 250 is a storage unit and/or device (e.g., a file system, database, collection of tables, or any other storage mechanism) for storing data. Further, a data repository 250 may include multiple different storage units and/or devices. The multiple different storage units and/or devices may or may not be of the same type and may or may not be located at the same physical site. Further, a data repository 250 may be implemented or executed on the same computing system as and/or a different computing system from the optical sensor apparatus 210. The data repository 250 may be communicatively coupled to the optical sensor apparatus 210 via a direct connection or via a network.

Information describing the optical sensor apparatus 210 may be implemented across any components within the system 200. However, this information is illustrated within the data repository 250 for purposes of clarity and explanation.

### 3. Operations for Optical Sensing and Emitting

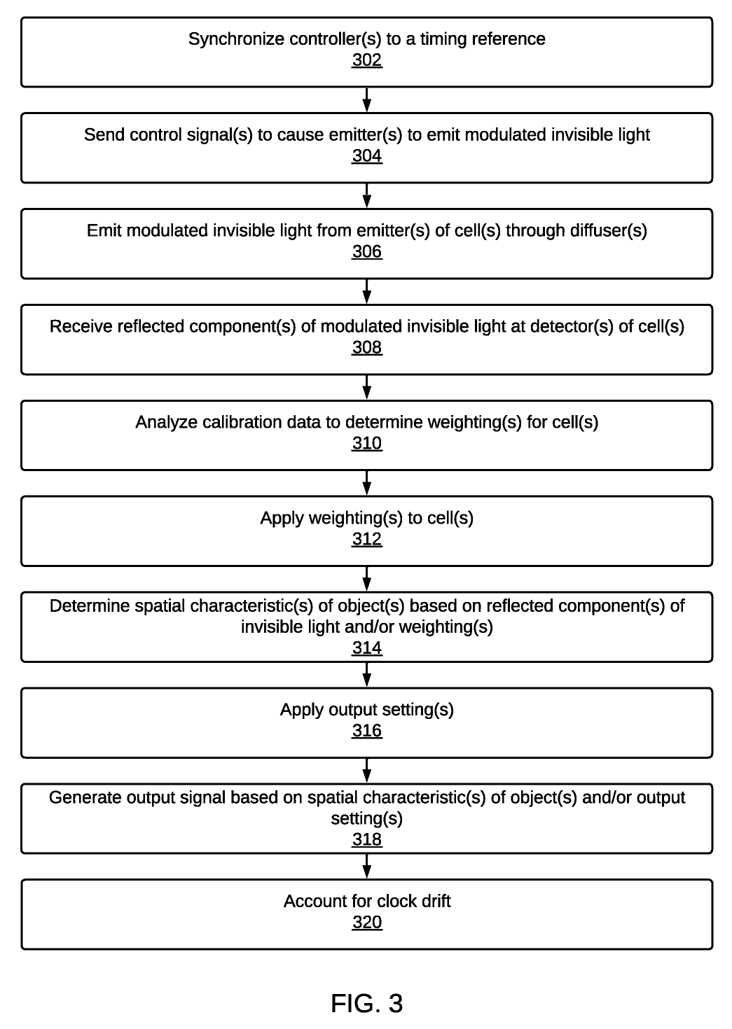

FIG. 3 illustrates operations for optical sensing and emitting, in accordance with one or more implementations. Operations described with reference to FIG. 3 may be performed by a display panel of an optical sensor apparatus, such as the optical sensor apparatus 210 of FIG. 2. One or more operations illustrated in FIG. 3 may be modified, rearranged, or omitted altogether. Accordingly, the particular sequence of operations illustrated in FIG. 3 should not be construed as limiting the scope of implementations.

In an implementation, the optical sensor apparatus synchronizes one or more controllers to a timing reference (Operation 302). For example, a synchronization module (such as synchronization module 213) aligns timing for one or more cells of a display panel of an optical sensor apparatus via one or more controllers [such as local controller(s) 228] using a synchronization signal that is distributed across the cells. In implementations, one or more controllers enter a scan-ready state responsive to a scan request from a main controller (such as main controller 211). The scan request may be forwarded across local controllers of cells of the panel along a serial communication path referred to as a “daisy-chain” of cells. Once the cells have received the scan request signal, the cells enter a ready mode. Once the cells have entered the ready mode, the last cell of the daisy-chain emits a synchronization, or “SYNC” signal. The synchronization signal propagates across the local controllers of the cells and aligns timing for light emission and sampling intervals. The aligned timing provides a shared temporal basis that the local controllers use to schedule modulation transitions for one or more emitters [such as emitter(s) 224] of the cell(s), and to schedule sampling for one or more detectors [such as detector(s) 226] of cell(s), during illumination intervals of the scan operation used to calibrate the display panel. In some implementations, the illumination intervals are performed group-wise, such that different groups are illuminated during different respective intervals.

In an implementation, the optical sensor apparatus sends one or more control signals to cause one or more emitters to emit modulated invisible light (Operation 304). For example, a main controller issues a scan request that identifies a scan sequence and/or a group illumination order. The scan request propagates through the cells via serial communication in a daisy-chain. One or more local controllers receive the scan request and decode a command included in the scan request that specifies an active cell group. In an example, local controllers generate drive signals for emitters that encode a temporal modulation pattern, such as a Manchester-encoded pseudo-random bit sequence, and the local controllers gate the drive signals to match a defined illumination duration for the active group.

In some implementations, the main controller sends a synchronization command after sending a scan command, after a predetermined delay that accounts for the transmission time of the scan signal through a daisy-chain of local controller of cells. In other implementations, the last local controller in a daisy-chain emits a synchronization signal. In still other implementations, the cells in a daisy-chain forward control messages downstream that account for the transmission time so that multiple cells assigned to an active group begin modulation in a synchronized manner.

In an implementation, the optical sensor apparatus emits modulated invisible light from one or more emitters of one or more cells through one or more diffusers (Operation 306). In the example, the emitters are implemented as infrared light-emitting diodes that emit infrared light in accordance with signals from local controllers that apply an on-off modulation pattern. In an example implementation, the local controllers apply the on-off modulation pattern at a modulation frequency on the order of 100 kHz.

In implementations, the emitted infrared light passes through one or more diffusers [such as diffuser(s) 222] positioned on or in front of the cells. The diffusers spread visible light to create a uniform and pleasing aesthetic appearance but can interfere with detection because the diffusers reflect infrared light from a cell back into the detector of the cell. In this case, the detector of a cell may be saturated by the light that is reflected off of the diffuser. The saturation of the detector results in challenges with determining object proximity. Since the detector is flooded by the reflected light from the emitter of the same cell, the detector struggles with measuring object presence by detecting light reflected off of the object. In an example, group-based illumination is performed by activating emitters associated with defined groups in sequence. For example, multiple cells in an active group simultaneously emit identical temporally modulated codes, and then multiple cells in a different active group simultaneously emit identical temporally modulated codes. In some implementations, multiple cells in an active group emit temporally modulated codes that have individual cell identifiers as well as identical group identifiers.

In an implementation, the optical sensor apparatus receives one or more reflected components of modulated invisible light at one or more detectors of one or more cells (Operation 308). For example, photodiodes receive infrared light that is reflected by an object located in front of the panel and also receive infrared light that is reflected from nearby surfaces and adjacent cells. Local controllers sample the electrical signals generated by the detectors during active group illumination intervals. The local controllers record and accumulate measurement values over defined time windows that are aligned to the modulation timing. For example, the local controllers store measured optical sensor data corresponding to reflected infrared light signals associated with different group illuminations and then transmit the measurements to the main controller.

In an implementation, the optical sensor apparatus analyzes the calibration data to determine one or more weightings for one or more cells (Operation 310). In this operation, a calibration module (such as calibration module 214) computes a per-cell magnitude value using calibration data and neighborhood relationship information. For example, the synchronization and/or calibration uses data that characterizes inter-cell adjacency, such as shared edge-length values to compute a per-cell magnitude value by summing neighbor contributions for the cell and computing an inverse weighting coefficient by normalizing the per-cell magnitude relative to a reference magnitude derived from the calibration data. The calibration module stores the resulting weighting coefficients as cell weight data for use in later processing stages.

In an implementation, the optical sensor apparatus applies the one or more weightings to the one or more cells (Operation 312). For example, a main controller (such as main controller 211) retrieves cell weight data and applies a weighting coefficient to a calibrated signal value derived from the optical sensor data and calibration data. Applying the weighting to the signal value produces an adjusted signal value that is a more precise indicator of proximity or occlusion of objects in the environment outside the panel. For example, the main controller applies weightings by dividing a calibrated row-average value for an optical data table for a cell by an inverse weight for the cell, resulting in a normalized value that accounts for differences in neighbor contributions across cells. In this example, the main controller stores the adjusted values in a table as updated or derived optical sensor data. The main controller uses the adjusted signal values to determine the output behavior of cells.

In an implementation, the optical sensor apparatus determines one or more spatial characteristics of one or more objects based on the one or more reflected components of invisible light and/or the one or more weightings (Operation 314). In an implementation, the main controller processes signal values associated with the reflected components to determine object presence or proximity across the face of the panel. The raw signal values for the measured invisible light are adjusted according to the weightings to more accurately determine degrees of object proximity or occlusion for the cells. For example, the one or more controllers determine an estimated position of an object by identifying a region of elevated adjusted signal values across cells. In the example, the main controller determines a proximity or overlapping extent of an object in the environment relative to the cells according to the adjusted signal values to identify a set of cells that are occluded by an object and/or a distance from the object to the cells.

As used herein, determining spatial characteristics includes detection of object presence, proximity, or occlusion. Detecting object presence, proximity, or occlusion may further include identification of an object and/or a contour of the object based on changes in detected optical signals relative to expected signal levels in the absence of the object. Object presence may be determined when a reflected component of an emitted light signal exceeds a detection threshold, while proximity may be inferred from relative magnitude, timing, or correlation strength of the detected signal. Occlusion may be identified when an object partially or fully blocks, absorbs, or redirects emitted light, resulting in attenuation or distortion of detected signals. In various implementations, these determinations are binary or multi-level and/or are derived from calibrated and normalized detection data, such that different sensing modes and operation modes are supported.

In an implementation, the optical sensor apparatus applies one or more output settings (Operation 316). For example, the main controller accesses settings data and sets values for parameters defining output signal behavior. Output signals can include sound of different pitch or volume or light of different colors or brightness. In various implementations, applying the output settings includes mapping parameters that relate determined proximity values to brightness levels and/or color of visible light emitted by the cells. In some implementations, the main controller transmits control messages to LEDs of cells that specify per-cell output characteristics determined based on the output settings and the spatial characteristics. In some implementations, the main controller sends a serial peripheral interface (SPI) command to “smart” LEDs in a cell to control the output of the cell. For example, a cell contains eight (or another number of) LEDs that are equipped with a SPI-enabled microchip. The main controller provides an SPI command to a smart LED chip via an SPI input, and the smart LED chip provides an SPI output to the LED to cause the LED to illuminate according to the SPI command. In other implementations, the main controller may interface with a local controller at a cell to cause the local controller to send an SPI command to a smart LED.

In some implementations, an interface provides user interface elements that accept user input defining configurable illumination settings of a display panel. In such implementations, the main controller updates output settings data based on the received input and then applies the updated settings data during subsequent illumination by the display panel.

In an implementation, the optical sensor apparatus generates an output signal based on the one or more spatial characteristics of the one or more objects and/or the one or more output settings (Operation 318). In this operation, the optical sensor apparatus outputs a signal, such as light or sound, in accordance with the output settings. In various implementations, the output settings define the output signal(s) based on the presence, absence, and/or proximity of one or more objects in the environment external to the apparatus. For example, the local controllers set a brightness level and a color value for a cell based on a proximity magnitude of an object for the cell and based on a mapping specified by the illumination settings. The local controllers update drive signals to LEDs over time as new proximity values are generated during object detection scans. In an implementation, visible light passes through a diffuser in a cell to produce a uniform visual appearance across the cell surface. The visible output varies across different cells of the panel according to the presence or proximity of one or more objects in the environment external to the optical sensor apparatus.

In one or more implementations, local controllers signal emitters, which may be the same as or separate from emitters used to emit non-visible light, to emit visible light from within the optical cells according to the control values generated by the main controller according to the illumination settings. In various implementations, emitters may include separate visible-light emitters and infrared emitters, or a combined emitter capable of both functions.

In various implementations, the output signal is generated based on an assessment of object presence based on one or more of a binary detection event, a proximity value, an occlusion metric, and/or a confidence measure. Output signals may be generated on a per-cell basis, aggregated across multiple cells, and/or processed over time to reduce noise or transient effects. The output signal may be provided to downstream components, such as a display controller or smart LEDs, and may be generated in real time or after application of filtering, thresholding, or temporal smoothing operations.

In an implementation, the optical sensor apparatus accounts for a clock drift (Operation 320). For example, a scan includes multiple different cell group illuminations. At the start of one or more group cell illuminations during a scan, a last cell in a daisy-chain for the group illuminations of the scan asserts a SYNC signal to account for clock drift. In some implementations, the system determines a worst-case timing drift for one or more cells corresponding to a threshold fraction of a bit-length of transmitted code. For example, the system accounts for clock drift so that the worst-case clock drift by the end of a group illumination is no greater than one-fourth (or another fraction) of a bit length in the transmitted code, to facilitate enhanced detection sensitivity.

In an implementation, the optical sensor apparatus resynchronizes one or more controllers by initiating a resynchronization event by asserting a SYNC signal at the start of a group illumination. In this example, the local controllers reset the modulation phases of the emitters and the sampling phases of the detectors responsive to the asserted SYNC signal. In some implementations, the main controller schedules resynchronization at the start of a group illumination so that the emitters begin a modulation code with a first bit interval aligned to the SYNC signal. In some implementations, the detectors begin a sampling window with a timing that is aligned to the SYNC signal. In this example, the resynchronization reduces correlation error by restoring temporal alignment between the temporal modulation pattern and the sampling schedule used to distinguish reflected components.

Optionally, or alternatively, the main controller evaluates timing alignment between modulation timing used for different emitters and sampling timing used for different detectors by comparing expected bit boundaries to bit boundaries of demodulated measurements. For example, local controllers track accumulated drift relative to a synchronization signal and report a drift metric to the main controller. In this example, the main controller uses the synchronization module to compare a drift metric to a stored drift threshold value. If the reported drift metric exceeds the drift threshold value, the synchronization module resynchronizes the emitters and detectors via the local controllers. In some implementations, the drift threshold value is maintained configurable and/or is maintained as settings data.

In some implementations, the optical sensor apparatus performs one or more operations to linearize and/or calibrate light signal data measured by detectors. For example, one or more implementations distinguish one or more reflected invisible light components from other light entering a detector by distinguishing detector samples associated with on-state emitters from detector samples associated with other light sources, based on temporal modulation. The one or more controllers compute a difference between accumulated on-state measurements and accumulated off-state measurements. In implementations, subtraction of off-state measurements from the on-state measurements is used to account for a baseline amount of ambient (invisible or visible) light. The subtraction is used to account for ambient infrared light as well as leakage of other light that passes into the detector. For example, some visible light may leak through an infrared filter of an infrared photodiode and into the detector. Accounting for ambient infrared light and visible light leakage into a detector results in a measured signal value of the on-state infrared light that is isolated from the other light. In some implementations, a main controller stores optical sensor data including signal value measurements associated with the different groups in a data repository table that is indexed by cell and/or by group and that may be used to adjust raw signal measurements to obtain adjusted signal measurements.

In an implementation, the optical sensor apparatus records calibration data during a calibration scan before normal operation. For example, a main controller initiates a scan sequence used for calibration that cycles through different cell groups by illuminating the different cell groups in series for respective time intervals in measurement cycles when no object is present and when an object is passed in front of the display panel. For example, prior to normal operation, the optical sensor apparatus records separate sets of data while no objects are proximate the apparatus and while an object is passed in front of the face of the apparatus near the cells. The main controller and/or local controllers record measured signal ranges (e.g., low values and high values) for the detectors of the cells. Once the data is collected, the apparatus determines calibration values that are used to determine the behavior of the cells during subsequent normal operation.

In this example, the main controller and/or the local controllers generate calibration data by recording minimum observed signal values and maximum observed signal values for one or more individual cells during the initial scan cycle used for calibration. The main controller derives scaling coefficient values from the recorded minimum and maximum observed signal values that are recorded during the initial scan cycle. These values are used to normalize the values of subsequent optical sensor data generated during subsequent scan operations cycles during subsequent normal operation. Optionally or alternatively, one or more implementations update the minimum and/or maximum observed signal values using one or more additional values measured during one or more scan cycles during normal operation. The updated minimum and/or maximum values may be used to update the scaling coefficient values.

### 4. Interactive Lighting Structure with Proximity-Sensing Optical Cells

In various implementations, an interactive lighting structure includes proximity sensing optical cells used to detect whether an object is present in the environment external to the structure. For example, a proximity-sensing optical cell includes an infrared proximity sensor having an emitter and a detector that operate by emitting infrared light and detecting a reflection of the emitted light off of nearby objects in the environment.

Aspects of the proximity sensing optical cells herein overcome challenges associated with performing proximity and/or location detection that involves light passing through an optical diffuser. Light passing through an optical diffuser presents unique challenges because when infrared light emitters or detectors operate in a cell from behind an optical diffuser, the diffuser reflects emitted light from the cell’s emitters back into the cell’s detector. Light being detected at the detector that reflected off of the cell’s diffuser as opposed to a nearby object in the environment outside the cell skews measurements intended to quantify the amount of light reflected off of the object. Without compensating for the effect, the detector of a cell would measure emitted light from the cell that is reflected off of the diffuser instead of (or in addition to) light that has reflected off of an object in front of the cell. Furthermore, diffusers attenuate emitted signals that pass through the diffusers and therefore reduce the strength of the light that reaches the detectors. This means that the amount of light from a cell’s emitter that is reflected off of a diffuser back into the cell’s detector may be much greater than the amount of light that reflects off of an object outside the cell and which has been attenuated by passing through the diffuser. In such cases, the accuracy and sensitivity of detecting an object of interest is greatly impaired because the light reflected by the diffuser saturates the detector and skews the magnitude of the measured light regardless of whether an object is present.

One or more implementations enable object detection and precise tracking using invisible (e.g., infrared) light regardless of the presence of optical diffusers by measuring light that enters a detector of a cell from other, different cells. Since the detectors are measuring light from other cells and not light originating from the same cells as the detectors, the effect of a diffuser reflected light from a cell back into the detector of the same cell is negated.

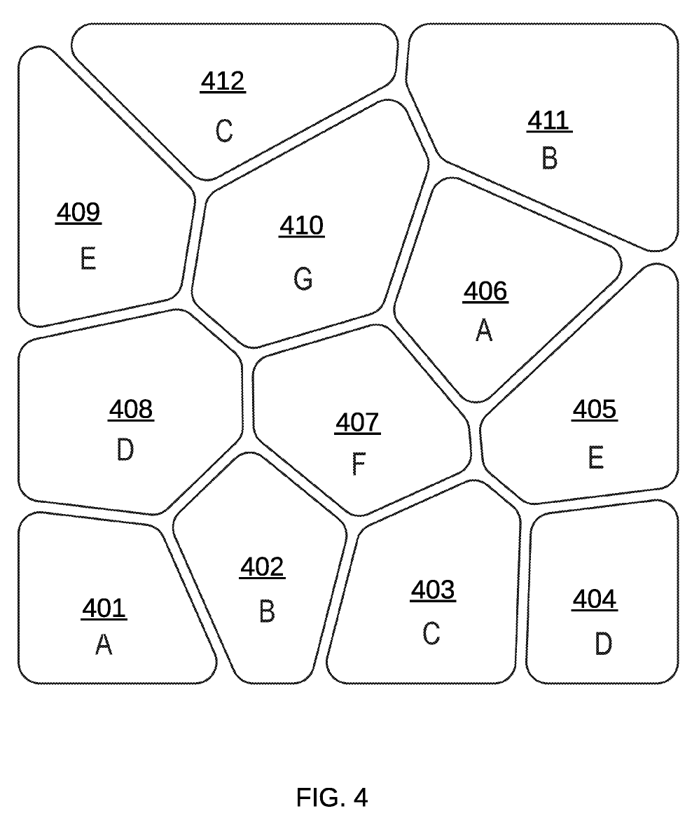

One or more implementations include an optical object detection mechanism in the form of a proximity sensing optical cell that is a feature of an interactive lighting apparatus such as a light sculpture. FIG. 4 illustrates an interactive lighting apparatus with proximity sensing optical cells, according to one or more implementations.

In the example of FIG. 4, the interactive lighting apparatus is configured as an interactive light sculpture 400. In this example, the sculpture 400 includes a set of color-changing cells that respond to the presence and/or proximity of an object within the environment around the cells. For example, as a person moves their hand in front of the display panel of the sculpture, the proximity of the hand to the cells is detected. In this example, an integrated controller adjusts the color and/or brightness of the cells accordingly, providing a satisfying interactive experience. In various implementations, the interactive light sculpture includes a wall-mounted display panel, a display panel that is integrated into a table, a display panel integrated or set into a wall, a display panel integrated into walls of a pool, or a display panel that is otherwise configured for presentation or display.

In general, implementations use a two-dimensional optical object detection array across a panel consisting of two or more polygonal or organically shaped areas referred to herein as “cells.” In the example of FIG. 4, the cells are approximately half the size of an open human hand. In other implementations, the cells may be larger or smaller, or may be a size proportional (e.g., one-fourth the size, half the size, a similar size, double the size, or a larger or smaller proportion) to a size of an object that is the target of the detection of presence or proximity.

One or more implementations of the display panel perform accurate assessment of the presence or proximity of an object, such as a human hand, near cells of the display panel regardless of the presence of optical diffusers within the cells of the panel. One or more implementations account for light reflected between cells to prevent reduction of the sensitivity and/or accuracy of object proximity detection that would otherwise occur in the presence of diffusers, in part because the diffusers would otherwise be detected instead of the object. In this way, such implementations of the display panel cells account for self-interference or cross-interference due to the diffusers used in the cells.

One or more implementations measure the specific amount of light reflected between adjacent cells in addition to measuring the amount of light being reflected back into a given cell. Doing so enables implementations to distinguish the light reflected between adjacent cells from other light reflected back into a given cell, which can include the light reflected between cells, the ambient light, and the light reflected from an object. In this way, implementations treat inter-cell reflections as a recurring and predictable background light that may be accounted for by normalization. In such implementations, a calibration scan generates an optical sensor data table matrix that represents the ambient background for the cells. During calibration, an object, such as an operator’s hand, is passed in front of the face of the display panel near the cells, to provide a “high reflection” reading from light from cells being reflected off of the object back into other cells.

In one or more implementations, proximity scanning occurs while groups of cells are illuminated in series. When a cell of a group of cells is being illuminated, an infrared blaster circuit in the cell sends out a series of pulses in such a way that the total period of time where the LEDs of the blaster are off is equal to the total period of time where the LEDs of the blaster are on (e.g., a 50% duty cycle). The cells in groups that are not being currently illuminated are taking readings from their respective ADCs and recording the on/off state of the infrared blasters at the time the ADC is sampled.

In various implementations, ADC readings are recorded by (i) recording on value and off values in separate data storage “buckets”; and/or (ii) recording signed (e.g., positive or negative) values in a single data storage bucket.

In implementations where two data storage buckets are deployed, one bucket is for accumulating readings when the infrared blaster is on, and the other bucket is for accumulating readings when the infrared blaster is off. As the values are read from the ADC, they are added to the appropriate bucket (e.g., the on or off bucket). Once the illumination is complete, the value of the "off" bucket is subtracted from the value of the "on" bucket. Negative values are clipped to zero. This value becomes the value for that group for that cell that is recorded as uncalibrated measured signal data.

In implementations using a single signed bucket, readings from when the infrared blaster is on are recorded as positive values and readings from when the infrared blaster is off are recorded as negative values in the bucket. After the illumination for that group is complete, the values in the bucket are summed. If the summed value for the bucket is negative, the value is clipped to zero. The summed value becomes the value for that group for that cell that is recorded as uncalibrated measured signal data. In the absence of overflow or underflow conditions, this approach produces mathematically identical results to the previous method that uses two buckets.

Once values are determined for the different cells for the different groups, the values are then sent to the main control board for further processing. In one or more implementations, some processing occurs on a microcontroller or local controller of a cell. The values may be applied in several ways to determine weightings, normalization factors, and/or linearization factors.

For example, during runtime of normal illumination operations after calibration, implementations subtract minimum values derived from an optical sensor data table matrix from other measured values to normalize measured values. In this way, such implementations account for background light to isolate the detected light that is due to object reflections.

In various implementations, synchronization signals, scan requests, and related control signals propagate across cells according to a defined communication topology, such as a daisy-chain, ring, bus, or hybrid configuration. In various implementations, signal propagation is unidirectional or bidirectional. In some implementations, a terminal or “last” cell or a designated terminal controller generates a synchronization response (e.g., a “SYNC” signal) to align timing across the panel. The identity of the terminal cell may be fixed or dynamically determined based on addressing, topology discovery, or fault conditions. In some implementations, signal propagation paths may be reconfigured in response to detected communication failures or topology changes, enabling continued synchronization and coordinated operation of remaining cells.

In an example implementation, detectors in cells communicate signals and measurements of light reflected between cells using a serial communication path referred to as a “daisy-chain” communication path or mechanism. Such a daisy-chain mechanism that serially measures light reflected between a series of cells is suitable for scaling to large numbers of cells.

In the example of FIG. 4, the cells in a panel are arranged in a non-uniform manner, such as a Voronoi diagram. In implementations, individual cells emit visible light that changes in response to objects being detected proximate to the individual cells. The visible light changes based on the presence and/or proximity of the object to produce an interactive user-feedback effect. The visible light is produced in addition to the invisible infrared light used for object proximity detection.

In some implementations, a display panel includes a large number of cells with local controllers in the cells. In some implementations with a small number of cells, such as two or three cells, scanning, measuring, processing, and illumination operations are performed by a single microcontroller. In other implementations, with a large number of cells, such as dozens or hundreds of cells, microcontrollers are included in the cells. However, some implementations with a large number of cells may use a single controller or any other number of controllers.

Initialization is the process by which the cells are given a unique sequential ID and assigned to a “cell group”. In FIG. 4, the illustrated cell groups are labeled A, B, C, D, E, F, and G. In the example, cell 401 and cell 406 belong to group A. Cell 402 and cell 411 belong to group B. Cell 403 and cell 412 belong to group C. Cell 404 and cell 408 belong to group D. Cell 405 and cell 409 belong to group E. Cell 407 belongs to group F. Cell 410 belongs to group G. In this example, the groups define a topological mapping of the cells of the display panel in which a particular cell belongs to a single respective group. The groups in this example are mutually exclusive, and at least two cells separate the cells of a group from other cells in the group. In other words, the set of cells that are adjacent to a cell in a group does not include cells that are adjacent to another cell in the group. Another way of defining the cells being separated by at least two cells may be by applying a rule that two cells cannot be in the same group if there is no way to draw a line between the cells that does not cross at least two other cells not in the group.

In this way, cell group membership is assigned such that cells in a group are separated from other cells in the group by at least two non-group cells. A grouping may be calculated once and re-used for the life of the panel.

Alternatively, or additionally, in some implementations, grouping may be recalculated any number of times from a cell neighbor list. In general, the number of groups is equal to one plus the number of neighbors for the cell with the most neighbors. In the example of FIG. 4, cell 407 and cell 410 are tied with the most neighbors with six neighbors, and the sculpture 400 has seven groups. In various other implementation, a cell with the most neighbors has eight or nine (or greater or fewer) neighbors, and the panel has nine or ten (or greater or fewer) cell groups. However, some implementations may use other cell group definitions, such as by requiring a greater number or fewer number of cells in between cells of a same group, by allowing a cell to be a member of multiple groups, and/or by allowing multiple groups to contain the same cell.

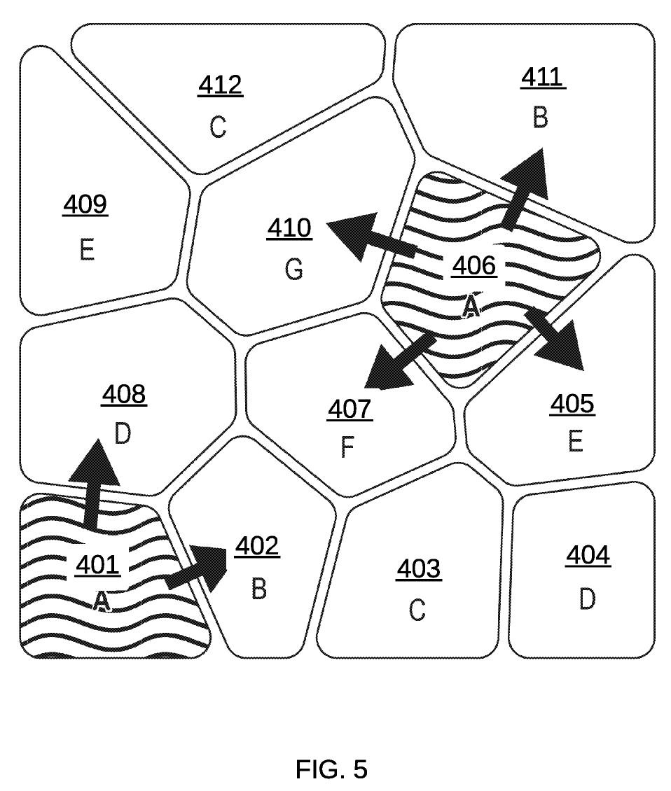

FIG. 5 illustrates a scan operation of the sculpture 400. During the scan operation, the groups are illuminated in sequence with modulated light. During an illumination of a group, cells in the active group transmit the same modulated code using infrared LEDs while cells in the other groups “listen” to detect the modulated light emitted from the LEDs. For example, cells in an active group emit light using a modulation frequency on the order of 100kHz, although higher or lower frequencies may be used, while other cells detect light and distinguish the components of the detected light emitted by the LEDs from other light by isolating components of the detected light that use the modulation frequency from other detected light. After the illumination period of a group, the group becomes inactive and a next group becomes active and sends another modulated code using infrared LEDs while groups other than the next group listen to detect the light. The groups become active in series, until the last group is active while the other groups listen to detect light from the last group.

In this example, the modulation code is a Manchester-encoded pseudo-random value of some number of bits (e.g., 16 or 32, or another number of bits), although other suitable modulation codes may be used. In various implementations, the modulation codes define the on/off states (e.g., duty cycles), the amplitude levels, and/or the phases of the emitted signals. For example, the modulation pattern may be shared among cells within an active group or may be distinct for different groups and/or individual cells to enable signal discrimination. During detection, a controller correlates sampled detector signals against the known temporal modulation pattern to distinguish reflected components of the emitted signal from ambient light and unrelated optical noise. In some implementations, different groups may employ different modulation patterns or phase offsets during respective group illumination intervals, enabling simultaneous or sequential detection operations while reducing crosstalk and improving robustness of object detection.

Synchronization operations establish a shared temporal reference among controllers sufficient to align emission transitions and detector sampling windows for correlation-based detection. Synchronization may be performed using a distributed synchronization signal propagated across cells and may include periodic re-synchronization to compensate for clock drift accumulated over time. Timing alignment may be maintained within tolerances appropriate for the selected modulation scheme and detection resolution, such that correlation between emitted and detected signals remains reliable. For example, the number of bits of the code is selected based on the expected worst-case clock-drift of the individual cells. Re-synchronization events may occur before a cell group emits a modulated light signal during a scan operation (e.g., in between emission of modulated light signals by different groups during the scan operation). Optionally, or alternatively, re-synchronization may occur at defined scan intervals, at startup, and/or in response to detected timing deviations (e.g., “clock drift”), and may involve adjustment of local timing offsets, phase alignment, and/or sampling schedules.

For example, the clock drift of a cell is accounted for so that the worst-case clock drift by the end of a group illumination is less than one-fourth of a bit length in the transmitted code. During group illumination operations during the scan, the last cell in a chain asserts a “SYNC” signal.

The SYNC signal is used to gate group illumination. For example, after a group illumination has occurred, cells in a daisy-chain wait until they receive a SYNC signal before they perform a subsequent group illumination. Instead of waiting to receive the SYNC signal, last cell in the chain (the cell that asserts the SYNC signal) waits a predetermined amount of time (e.g., one to ten microseconds, or a greater or shorter amount of time). In some implementations, the last cell in a daisy chain for a group illumination waits a predetermined amount of time (e.g., one to ten microseconds, or a greater or shorter amount of time) after group illumination before asserting the SYNC signal, then waits for another predetermined amount of time (e.g., one to ten microseconds, or a greater or shorter amount of time), and then de-asserts the SYNC signal. In this example, after receiving the SYNC signal, the cells in the daisy-chain other than the last cell also wait the predetermined amount of time (or a similar amount of time) before initiating the subsequent group illumination. In this way, the cells of the daisy-chain are synchronized to the same (or nearly the same) point in time. Aligning the cells between group illuminations in this manner re-synchronizes the cells to reduce or eliminate inaccuracies due to clock drift. Accounting for clock drift in this way enhances the sensitivity of detecting objects.

### Example Optical Cells

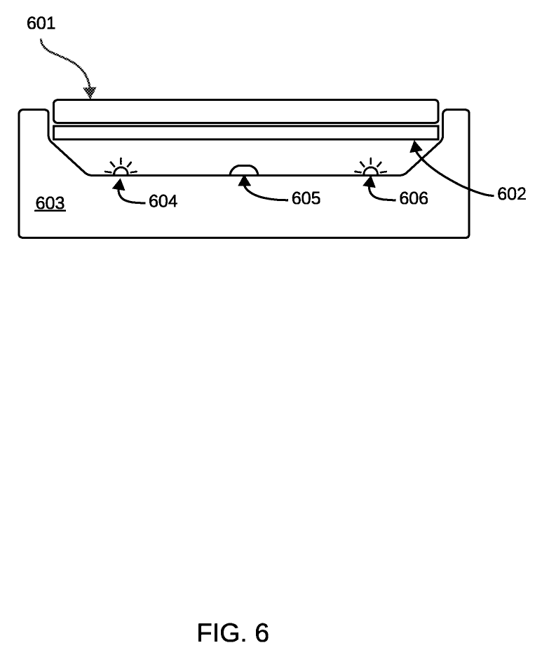

FIG. 6 illustrates a proximity-sensing optical cell of the lighting structure. In FIG. 6, a cell 600 includes a lens 601, a diffuser 602, infrared light emitting diodes (LEDs) 604, 606, and an infrared photodetector 605. In the example, the cell 600 is set into a cell frame 603. In some implementations, the lens 601 and diffuser 602 are combined into a singular part. In some implementations, the cell 600 includes one or more additional optical layers, such as brightness-enhancing films or attenuators, that are included with the diffuser and/or lens. In some implementations, a cell has its own microcontroller that is configured to: (i) control infrared LEDs 604, 606, (ii) monitor an infrared photodetector 605, and/or (iii) communicate (e.g., send and/or receive) control messages along a daisy chain of cells.

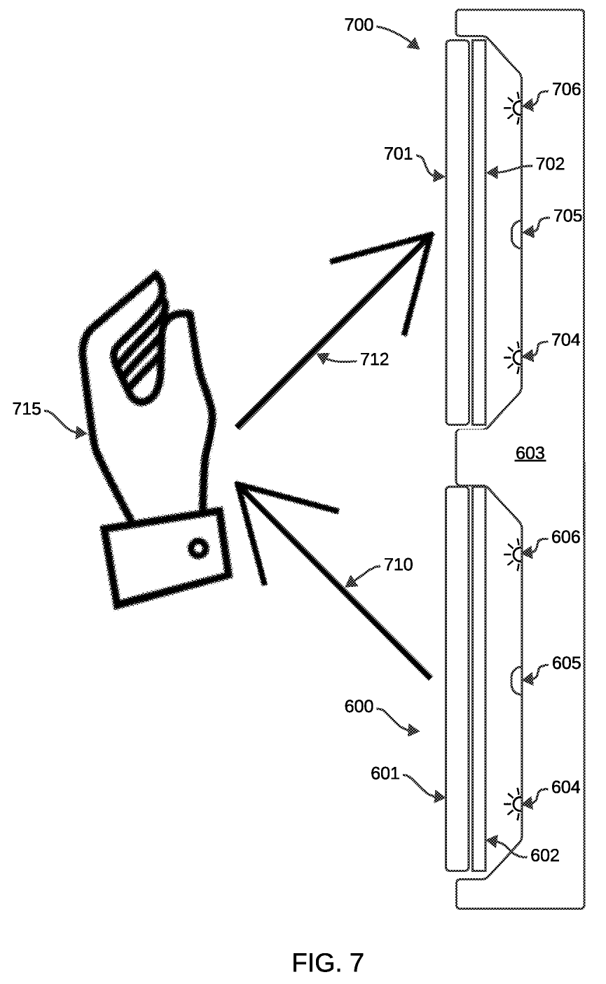

FIG. 7 illustrates an implementation of proximity-sensing optical cells. In FIG. 7, a cell 600 and another cell 700 are arranged next to each other and configured such that light 710 from cell 600 reflects off of an object 715 and is detected at cell 700. In the example, the cell 600 includes a lens 601, a diffuser 602, an infrared photodetector 605, and infrared LEDs 604, 606. The cell 700 includes a lens 701, a diffuser 702, an infrared photodetector 705, and infrared LEDs 704, 706. In the example, the cell 600 and the cell 700 are set into a cell frame 603.

In the example, the light 710 emitted from the infrared LEDs 604, 606 passes through the diffuser 602 and the lens 601. A reflected component 712 of the light 710 reflects off of an object 715 and travels toward the cell 700. The reflected component 712 passes through the lens 701 and the diffuser 702 and is detected at the infrared photodetector 705. The infrared photodetector 705 measures one or more properties, such as wattage per square unit of area, of the reflected component 712. The one or more measured properties are used to determine an amount or type of illumination output by the cell 700 and/or are stored in a data table of optical sensor data used to calibrate at least one of the cells 600, 700. Although the lens 601 and the lens 701 are shown as separate components, and the diffuser 602 and the diffuser 702 are shown as separate components, the lens 601 and the lens 701 may be integrated into a singular component having two separate areas of curvature for concentrating or dispersing light rays. Also, the diffuser 602 and the diffuser 702 may be integrated into a single component that diffuses light from the LEDs 604, 606, 704, 706 and/or light received by the photodetectors 605, 705. Further, both the lens 601, the lens 701, the diffuser 602, and the diffuser 702 may be integrated into a single component. Although FIG. 7 illustrates light being emitted from cell 600 and detected at cell 700, in various implementations, light is emitted from cell 700 and detected at cell 600 in a similar manner. Although two cells are shown in FIG. 7, various implementations include one or more additional cells, additional controllers, additional detectors, additional emitters, and/or additional optical diffusers. In implementations, cell 600 and cell 700 are in different groups that are subsets of the complete set of cells of the panel, and one or more additional cells are in another group that is an additional subset of the complete set of cells of the panel.

### Example Serial Daisy-Chain Communication Path

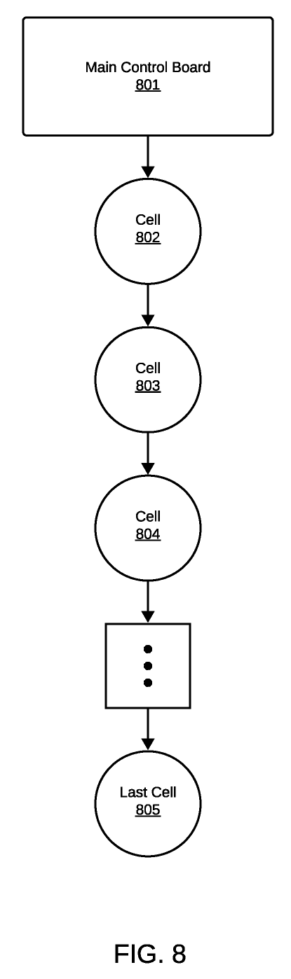

FIG. 8 illustrates a communication flow for a set of proximity-sensing optical cells. In FIG. 8, the proximity-sensing optical cells are connectively arranged in a daisy-chain 800. The daisy-chain configuration helps the system to scale to large sizes without bound.

In FIG. 8, the first device in the daisy-chain 800 is a main control board 801, which coordinates the operation of a series of cells 802, 803, 804, one or more additional cells, and/or a last cell 805. In the example of FIG. 8, the main control board 801 and the cells 802, 803, 804, 805 are connected using point-to-point links, whereby the cells 802, 803, 804 have a "port" marked "upstream" (or "in") and a port marked "downstream" (or "out"). The "downstream" port of one cell connects to the "upstream" port on the next cell. For example, the downstream port of cell 802 connects to the upstream port of cell 803. In some implementations, the daisy-chain is reconfigured so that a cell other than cell 805 is a last cell. Therefore, the last cell 805 may also have upstream and downstream ports.

Although a daisy-chain configuration is described herein, one or more other implementations use a shared bus to connect the cells 802, 803, 804, 805. In such implementations, the shared bus is configured to handle addressing, collisions, leader election, and other operations that are used to assert and/or distribute signals.

In the example of FIG. 8, the main control board 801 has a single downstream port which is connected to the upstream port of the first cell. However, in some implementations, the main control board 801 may have additional downstream ports and/or one or more upstream ports.

In this example, the electronic signals through the cells 802, 803, 804, 805 include (i) an asynchronous serial communication, (ii) a RESET signal, and/or (iii) a SYNC signal. In one or more implementations, the asynchronous serial communication is a multi-tap, terminated communication bus, or includes two independent bi-directional communication ports (one for upstream, one for downstream). In one or more implementations, the RESET signal is used to bring one or more local controllers (e.g., one or more microcontrollers) of the cells 802, 803, 804 into a predefined or known state. In one or more implementations, the SYNC signal is used to synchronize the local controllers (e.g., one or more microcontrollers) of the cells 802, 803, 804, 805 during scanning.

In one or more implementations, the asynchronous serial communication uses a high-speed universal asynchronous receiver-transmitter (UART) protocol. The main control board 801 sends one or more requests to the cells 802, 803, 804, 805 and the cells 802, 803, 804, 805 communicate with the main control board 801 in response to the request(s). For example, a request is forwarded from the main control board 801 to cell 802, from cell 802 to cell 803, from cell 803 to cell 804, from cell 804 to one or more additional cells, and so forth, until the request reaches a destination cell such as last cell 805. In various implementations, some requests are targeted to a specific cell and/or are "broadcast" to multiple cells. When a request is broadcast to multiple cells, the multiple cells reply.

Although proximity detection signals are described herein, one or more implementations of the daisy-chain communication path also use other signals, such as LED control signals, or another control signal, that are unrelated to object proximity detection.

In the example, a request for a scan by the main control board 801 includes group information, temporal modulation information, and/or an identifier that identifies the last cell 805 in the chain 800. The cells 802, 803, 804, in the chain 800 pass the scan request downstream and wait for the “SYNC” signal to be asserted by the last cell 805 in the chain 800 before continuing. The assertion of the “SYNC” signal by the last cell 805 in the chain 800 triggers the other cells 802, 803, 804 to start the scan process used for calibration.

The scan process used for calibration proceeds in a group-wise manner whereby cells of an active group emit infrared light in an “on” state while the cells of one or more other, non-active groups are in an “off” state and do not emit infrared light. While the cells in the active group are emitting light, the other cells in the non-active group(s) measure the amount of infrared light that is reflected into the cell(s) of the non-active group(s) over the modulation period of the group scan operation for the active group.

In this example, the cells of the active and non-active groups have been synchronized by the “SYNC” signal. One or more cells of one or more non-active groups, referred to as the "listening" cells, determine whether a particular active cell and/or active cell group’s infrared LEDs are on or off for a point in time during the group-wise cell illumination based on the synchronization. In this way, a cell measures how much invisible light from an active group has reached the cell and distinguishes the light from the active group from other sources of light.

are on or off is used to determine to what dataset light signals measured at a particular cell belong. For example, an inactive cell records separate measurements from that cell’s photodetector for (i) emitters of an active group while the infrared LEDs are on and for (ii) emitters of the active group while the infrared LEDs of the active group are off. In this example, when an active group is transmitting a one, emitters of the active group are on. When the active group is transmitting a zero, emitters of the active group are off. A receiving cell compensates for ambient light when the receiving cell demodulates received the signals by subtracting the measurement from the active group while the infrared LEDs of the active group are off from the measurement for the active group while the infrared LEDs of the active group are on. In this way, the light emitted from the active cells is quantified without introducing error from ambient light. Described differently, the samples from when an active groups’ infrared LEDs are known to be off is considered a baseline reading, and the samples from when the active group’s infrared LED is known to be on are measured as a difference from the baseline reading by subtracting the value of the baseline reading from the values of the samples from when the active groups’ infrared LEDs are known to be on.

This process is repeated sequentially for the different groups, with one or more cells of the different groups producing the measured infrared signal for the different groups. In general, the measured signal for a cell's own group is either ignored or not collected due to low-quality. However, in some implementations, one or more cells perform measurements for an active cell group even if they are in the active cell group. At the conclusion of scanning, the cells send the results upstream to the main control board 801. Sending the results upstream may include local controllers of the cells forwarding results from controllers of downstream cells to one or more upstream local controllers and/or to the main control board 801.

### Example Optical Sensor Data and Calibration Tables

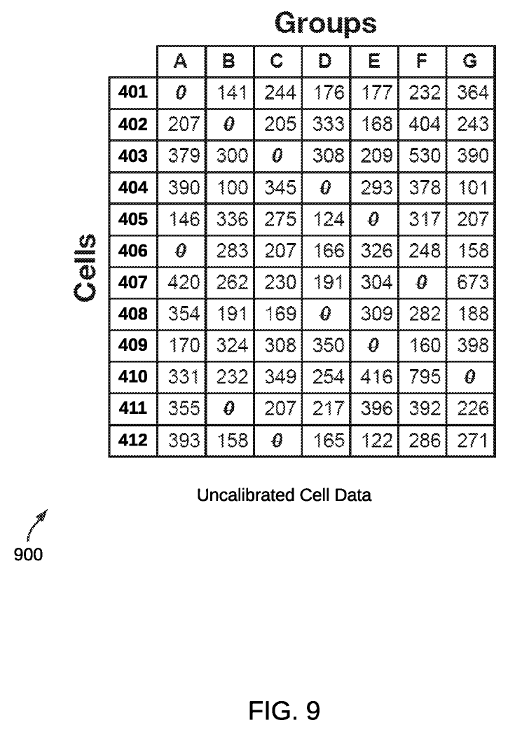

After a scan operation, the main control board populates one or more tables of optical sensor data values. FIG. 9 illustrates a table 900 of uncalibrated light detection data. In FIG. 9, the rows of the table are indexed by cells, and the columns of the table are indexed by cell groups. The different signals measured for the cells for the groups are recorded on this table. As used herein, a ‘row’ refers to a defined grouping of sensor measurements associated with a given cell, such as a set of photodetector readings spatially or electrically coupled within that cell, and a ‘row sum’ refers to an aggregate of those measurements.

In various implementations, calibration processes are performed to establish baseline operating parameters for the display panel and to compensate for variations among cells, components, and/or environmental conditions. Calibration may be performed during manufacturing, during installation, at system startup, periodically during operation, and/or in response to detected changes in operating conditions.

In an example implementation, calibration is performed prior to an illumination mode of the display panel. In this example, an operator calibrates the display panel during calibration by waving their hand, or by moving another object, across the face of the display panel. In general, when no object is present during calibration, the detectors of the cells will measure a relatively lower reading compared to when a reflective object is close to the face of the panel near the cells. When a reflective object is close to the face of the panel near certain cells, those cells will measure a relatively high reading.

In this manner, the example calibration operations include measuring relatively higher and relatively lower signal values to determine minimum and maximum detected signal values for the cells. These values are stored and subsequently used to establish mapping functions that map the measured values of detected light to outputs during illumination operations. Calibration parameters may be maintained on a per-cell basis, per-group basis, and/or for the panel as a whole.

In various implementations, measurements using different units and/or magnitudes are linearized and/or normalized. For example, a measurement of one-half of a milliwatt per square meter (0.5mW/m²) is measured for a cell, but the measurement is recorded into the table as a value of two-hundred units. Another measurement of one-quarter of a milliwatt per square meter (0.25mW/m²) is measured for another cell, so the measurement is recorded into the table as one-hundred units, since half as much light is being reflected into the cell. In other words, the units used to record values into the tables may be linearized and/or normalized as compared to the units of light measurement.

The initial values that are measured and recorded during calibration are uncalibrated values. As values are sampled both while an object is present and when no object is present, implementations record the extrema values for cells and/or groups in a lowest-value table and a highest-value table. The values in the tables are used to shift, scale, linearize, and/or normalize light signal data. In various implementations, these recorded values are used to calibrate the display panel by one or more of (i) minimum/maximum scaling, (ii) neighbor weighting, and/or (iii) ambient light subtraction.

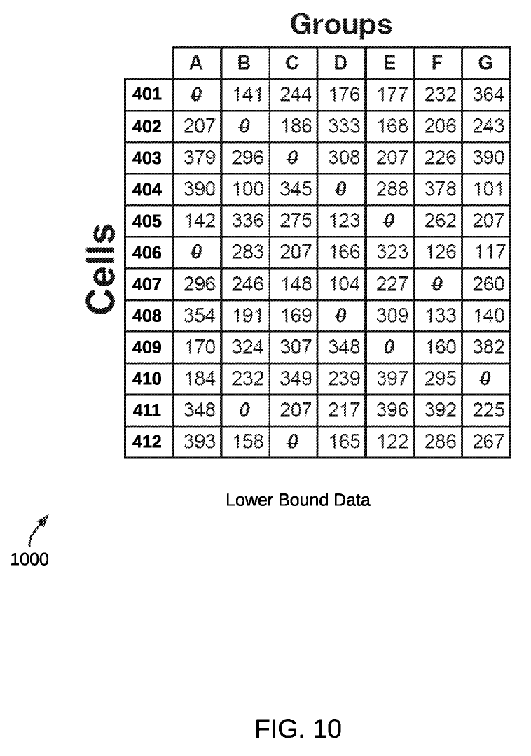

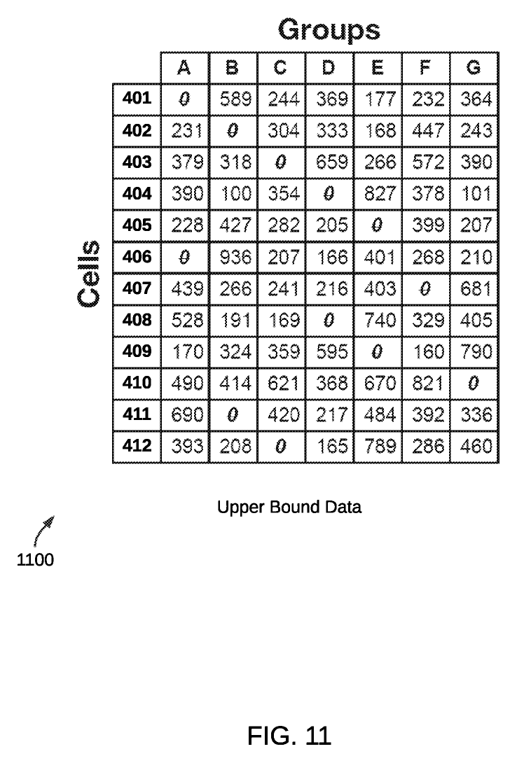

For example, FIG. 10 illustrates a table 1000 of lower-bound light detection data. FIG. 11 illustrates a table 1100 of upper-bound light detection data. In this example implementation, the table values are shifted and scaled with a linear transformation. The transformed data values are stored as calibrated light proximity data. To compensate for non-uniform sensitivity, the system may keep track of the highest recorded values for the averages per-row and divide the averages by this value.

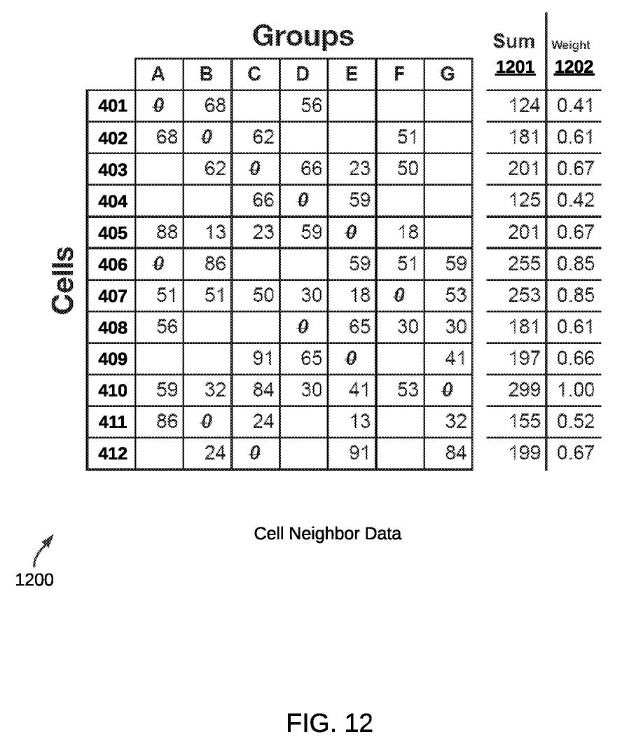

Additionally, or alternatively, one or more implementations calculate coefficients using data corresponding to a cell's neighbor(s). FIG. 12 illustrates a table 1200 of cell neighbor data. In various implementations, detection data associated with a cell is adjusted using weighting factors derived from spatial relationships between the cell and neighboring cells. Neighbor-based weighting accounts for physical characteristics of the panel, such as non-uniform spacing, edge effects, cell size, or variations in cell geometry, which may cause detected signal levels to differ across locations. Weighting factors may be determined based on adjacency information, relative distances, shared edges, cell size or geometry, and/or other topological relationships, and may be stored in association with the cells to which they apply. For example, a neighbor weight for a cell with three or more neighbors is derived from a first edge length of a first edge of the cell neighboring the first neighbor cell, a second edge length of a second edge of the cell neighboring the second neighbor cell, and a third edge length of a third edge neighboring the third neighbor cell, and so forth.

In an example implementation, edge lengths of cell neighbors for a cell are stored as neighbor weight data. In some cases, the edge lengths for cells are summed based on group membership. In some implementations, neighbor-based weighting is applied during calibration, during real-time detection processing, or as a post-processing step applied to calibrated detection data. Weighting factors may be predetermined or empirically derived based on cell topology. By applying neighbor-based weighting, the system improves accuracy, sensitivity, and uniformity of proximity or occlusion measurements across the panel.

In FIG. 12, rows in the table have been added together to produce sums in a sum column 1201. The computed sums are used to quantify relative magnitudes of the cells. The values in the sum column 1201 are normalized by dividing the values by the largest value in the sum column 1201, resulting in inverse weights that are recorded in the weight column 1202.

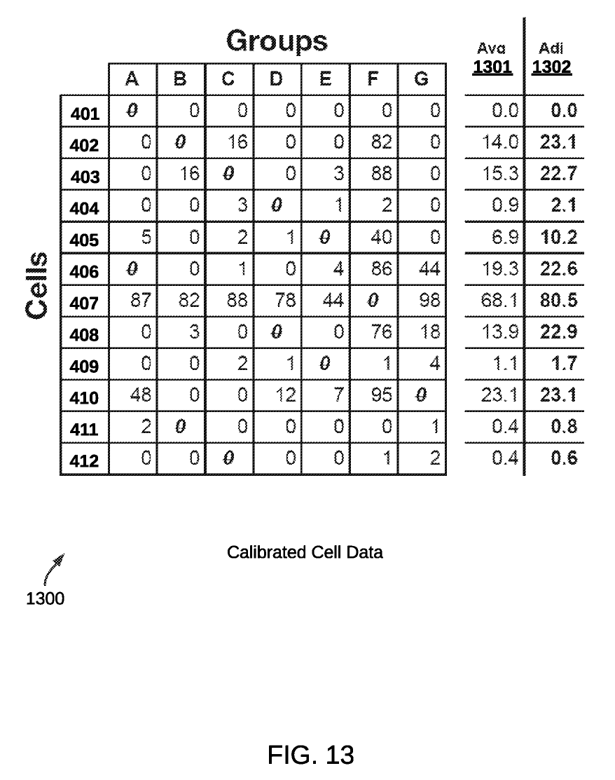

FIG. 13 illustrates a table of calibrated light data. In one or more implementations, the inverse weights in the weight column 1202 from the neighbor weight table 1200 are applied to a column 1301 of calibrated row averages to get final adjusted occlusion values illustrated in column 1302. For example, the calibration table entries are used to calculate the adjusted values of column 1302 by dividing the values of the column 1301 of calibrated row averages by the corresponding inverse weights of the weight column 1202 of the neighbor weight table 1200. Using these adjusted calibration values instead of raw values to determine cell occlusion behavior significantly improves uniformity of the calculated occlusion across the panel and results in smoother, more accurate, and more uniform effects produced by the panel.

Once calculated, the calibration coefficients can be stored and reused. In various implementations, the calibrated data is interpreted in one or more of several different ways depending on operation mode. For example, the values may be used to determine whether a measurement for a cell exceeds a threshold or satisfies one or more criteria that determine whether the cell is illuminated. In another example, the values are input into a fluid dynamics model, so that the display panel reacts fluidly to object occlusion. In various other implementations, the values are algorithmically used to result in different behaviors of the cells of the panel. Calibration may be performed once, periodically, continuously, or conditionally, depending on the implementation.

One or more implementations use average measured sensor data values, such as the average values recorded in column 1301, as approximations for the occlusion of cells. However, one or more implementations further weight the average values recorded in column 1301 using values derived from the geometry and/or topology of the cells of the panel to further improve the sensitivity of the cells. For example, some cells, such as cell 410 of FIG. 4 receive light that is not reflected off of an object from relatively more neighboring cells (cell 410 has six neighbors in the example of FIG. 4), whereas other cells, such as cell 401 of FIG. 4, receive light that is not reflected off of an object from relatively fewer cells (cell 401 has two in the example of FIG. 4). Without compensating for such differences in the amount of light received from neighboring cells, the panel may not behave smoothly and uniformly. Differences in the number of neighboring cells, the sum length of adjacent neighbor cell edges, and/or the area of neighboring cells can skew the measured values such that the resulting averages may not fully reflect object proximity uniformly across the panel. By compensating for the neighboring cells using adjacent edge lengths and/or cell areas, more precise values for the wattage per square unit of area detected at the cells are obtained. The more precise values help the interactive display panel to be more dynamic, with increased sensitivity and responsiveness to interacting objects.

In an example, the detector associated with a cell produces a raw signal value proportional to detected light intensity, but the relationship between raw signal value and actual reflected light from an object may be non-linear due to factors such as sensor characteristics, optical diffusion, or panel geometry. In the example, and with reference to FIGS. 9-13, during calibration, the system determines that the detector of cell 402 measures a raw, uncalibrated signal for group C of 205 units. The detector of cell 402 for group C measures a minimum raw value of 186 units, such as when no object is present or when a light-absorptive object is present. The detector of cell 402 for group C measures a maximum raw value of 304 units, such as when a reflective object is nearby. Based on these calibration points, a linearization function may be derived to map the detector measurements to linearized values. For example, a raw measurement of 205 may be linearized by subtracting the minimum value (205 − 186 = 19) and dividing by the calibrated range (304 − 186 = 118), yielding a linearized value of 0.16 (19 divided by 118). This linearized value represents a proportional measure of reflected signal strength relative to the calibrated operating range and is used as an intermediate value for further processing.

In the example, the linearized detection data is normalized to a standardized numeric range to enable consistent interpretation across cells and system components. Continuing the previous example, a linearized value of 0.16 may be normalized to an integer range of 0–100 by multiplying the linearized value by 100, resulting in a normalized proximity value of 16. In another implementation, a linearized value may be normalized to an 8-bit range of 1–255 by multiplying the linearized value by 254 and adding an offset of 1, resulting in a normalized value of approximately 42. Such normalized values are also used as intermediate values for further processing.

In one or more implementations, the normalized measured values are further weighted according to the cell neighbor data. For example, the group-wise sums of adjacent cell edges for cells are recorded in FIG. 12. The total sums for the cell edge length of adjacent cells for the cells are recorded in a sum column 1201. The total sums in the sum column 901 are divided by the maximum sum in the sum column 1201 (the value 299, for cell 410, in FIG. 12) to result in neighbor weights that are represented in the weight column 1202. For example, the total neighbor edge length for cell 402 is 181 (68 + 62 + 51 equals 181). The weight for cell 402 is 0.61 (181 divided by 299 equals 0.61).

Continuing the previous example for cell 402, the normalized values for cell 402 are averaged, and the result is recorded in the calibrated row averages column 1301. In this example, the sum of normalized values for cell 402 is 98 (0 + 0 + 16 + 0 + 0 + 82 + 0 equals 98) and the number of normalized values is 7 (corresponding to groups A-G). Therefore, the average for cell 402 recorded in the average column 1301 is 14 (98 divided by 7 equals 14). This value is divided by the corresponding value from the weight column 1202 (0.61 in the example), to result in the adjusted value 23.1 (14.0 divided by 0.61 equals 23.1) shown in the adjusted value column 1302. In this way, measured values are normalized based on minimum/maximum values and neighbor weights to result in adjusted, calibrated values. The adjusted values are subsequently compared against threshold values to determine whether a cell should be illuminated, and/or are mapped to characteristics, such as color or brightness, of illumination, that depend on the value. Normalizing the measured values and using the adjusted values to determine cell illumination properties in this manner ensures smooth, uniform illumination behavior across the panel that accounts for variations in absolute sensor gain or cell-to-cell variation.

One or more implementations collect sensor data during calibration by moving an object, such as an operator’s hand, across the panel, from edge to edge, covering the entire panel. While the object is being passed in front of the panel, sums of values for cells are calculated and used to define a "low" and "high" level for the cells. In this example, a "low" level is the lowest sum observed for a cell, and a "high" value is the highest sum observed for the cell.

In one or more implementations, the "low" and "high" levels for a cell are adjusted based on a ratio to reduce noise: For example, an adjusted low level value, “AdjLow,” is calculated by multiplying the low level value by seven, adding the high level value, and dividing by eight (e.g., (low * 7 + high) / 8 = AdjLow). As another example, an adjusted high level value, “AdjHigh,” is calculated by adding the low level to the high level value multiplied by eleven and dividing the sum by twelve. (e.g., AdjHigh = (low + high * 11) / 12). This implementation results in AdjLow being little higher than the low level value and AdjHigh being a little lower than the high level value. compared to the previous readings. These formulas and/or coefficients improved performance during experimentation.

Once calibration is complete, some implementations further use the AdjLow and AdjHigh values to normalize the measured values for row sums, “Measured,” for the cells to determine a normalized value, “Normalized”, according to the following formula: Normalized = 255 * (Measured - AdjLow) / (AdjHigh - AdjLow). In this example, the normalized values are clamped between 0 and 255. The clamped values are then used to represent the approximate proximity of a target object such as a hand (or other reflective object) to the cells. Some advantages to implementations utilizing this method include: (i) facilitation of calculating approximate cell proximity for downstream use; (ii) ease of implementation; (iii) reduction of bandwidth by performing the summations and/or other calculations using the local microcontrollers at individual cells; (iv) reduction of noise from performing summation of rows for a cell.

Additionally, or alternatively, one or more implementations perform the following normalization and/or summation to normalize data for cell proximity determination. In this example, measured raw signal data is normalized using low and high values determined from calibration. In this example, calibration may be performed similarly to one or more calibration methods previously discussed. In this example, a high level value and a low level value is recorded for each individual cell value in the table, as opposed to recording high level values and low level values for sums of rows. In this example, the same formula for determining AdjLow (e.g., AdjLow = (low * 7 + high) / 8), AdjHigh (e.g., AdjHigh = ( low + high * 11) / 12), and Normalized (e.g., Normalized = 255 * (Measured - AdjLow) / (AdjHigh - AdjLow)) values are deployed, using the individual cell values instead of the row sum values. In different implementations, normalization may be performed before or after summation and/or weighting, provided that the same calibration bounds are applied consistently within a given scan cycle.

In this example, normalizing values in the rows individually, results in groups having the same weight for a row. In some cases, this results in some cells being more sensitive than others. To correct this, one or more implementations apply pre-calculated weights to the values in the uncalibrated raw signal data table prior to row summation. In various implementations, these weights are calculated using one or more of several ways methods.

Some implementations use the lengths of the edges of neighboring cells to a cell. In such implementations, for a row of uncalibrated data, a sum of the row is calculated. Then, the different cell values in the row are divided by the sum for that row. The resulting values of the cells of a row divided by the sum for that row are applied as weights to normalized measurements to account for cell sensitivity. The adjusted, normalized measurements for a row are summed to indicate a final cell proximity value for the row that is used as a basis for determining the response of the cell to the proximity. Some advantages to this method include (i) calculation of approximate cell proximity for downstream use; (ii) disregards readings for a particular cell from groups that do not include a cell that is adjacent to the particular cell to reduce the amount of unintended proximity detection in larger sculptures from non-targeted objects (e.g., clothing); (iii) accounts for individual cell sensitivity; (iv) conserves bandwidth by sending calibration data to cells before scanning.

One or more implementations perform normalization and/or correlation that is based on edge proximity of cells. Such implementations reduce the amount of information about object proximity that is otherwise lost due to summation steps. Some implementations use a cell proximity approach whereby a cell has an associated proximity value that roughly represents how close that cell is to an object. The previous methods discussed above use this approach to approximate how close cells are to an object, but such methods face challenges due to the diffusers within the cells complicating the cells being able to individually act as proximity detectors. Such methods face challenges because optical diffusers within the cells can cause light from a single object to be distributed across multiple neighboring cells, thereby reducing the accuracy of proximity estimates derived from individual cell measurements.

One or more implementations use an edge proximity approach to more accurately measure real object proximity. Instead of detecting the proximity of objects to cells, edge proximity approaches detect the proximity of objects to the edges between cells. Such implementations determine an estimated edge proximity instead of an estimated cell proximity. Estimating edge proximity results in a more granular approximation of object proximity and enables utilization of information that is not considered by cell proximity approaches. In this way, an edge proximity approach is more effective at calculating exact object positions than the cell proximity data approaches previously described.

To determine object position using an edge proximity approach, implementations normalize the uncalibrated signal data values for a reading similarly to the normalization performed using the cell proximity approach. Next, the table of normalized values is converted into an ordered list of edge readings in a "correlate" step using an algorithm or other suitable method. Implementations use pairs of cells as a proximity detector. As a result, two readings for an edge between a pair of cells are obtained. In this approach, edge proximity is calculated from such a pair of values from the normalized table. Some implementations average this pair of values. In other implementations, a value of the pair of values, such as a value with a lower confidence, is discarded. In general, averaging the two values produces a higher-quality proximity reading with less noise. Advantages of the edge proximity approach include (i) increased accuracy of object proximity detection; (ii) greater utilization of collected data; and (iii) reduction in unintended proximity detection of non-target objects (e.g., clothes) by exclusion of readings from non-adjacent groups (e.g., groups that do not have a cell that is adjacent to a particular cell).

In some implementations, cell proximity approaches may be refined by applying two values for a particular edge. For example, a first measurement for a first edge of a first cell that is adjacent to a second edge of a second cell and a second measurement for the second cell may be used together to reduce noise in cell proximity approaches. Such implementations add a step to the cell proximity approach by averaging pairs of values that correspond to the same edge and replacing the individual values corresponding to that edge with the averaged values. Doing so reduces noise and improves overall performance even for cell proximity approaches.

### 5. Hardware Overview

According to one or more examples, some aspects of the techniques described herein are implemented by one or more computing devices (e.g., in implementation of the main controller 211, local controllers 228, and/or other hardware). The computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, FPGAs, or NPUs with custom programming to accomplish the techniques. In some implementations, the interactive panel may be coupled to one or more external computing devices that may provide various control or command functions, such as, for example, desktop computer systems, portable computer systems, handheld devices, networking devices, or any other device that incorporates hard-wired and/or program logic to implement the techniques.

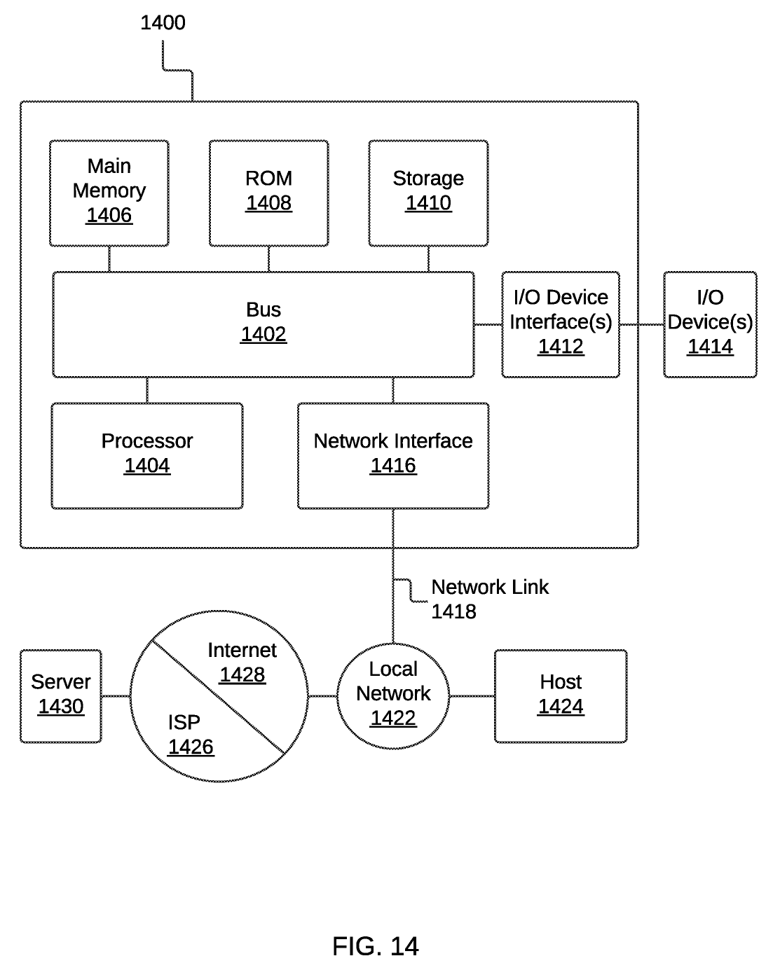

For example, FIG. 14 is a block diagram that illustrates a computer system 1400 upon which one or more aspects of the disclosure may be implemented. For example, one or more controllers or microcontrollers include one or more aspects of the example computer system 1400. In FIG. 14, computer system 1400 includes a bus 1402 or other communication mechanism for communicating information, and a hardware processor 1404 coupled with bus 1402 for processing information. Hardware processor 1404 may be, for example, a general-purpose microprocessor.

Computer system 1400 also includes a main memory 1406, such as a random-access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk, optical disk, or a Solid-State Drive (SSD) is provided and coupled to bus 1402 for storing information and instructions.

In one or more implementations, computer system 1400 may be coupled via bus 1402 to one or more input and/or output (I/O) device interfaces 1412 that allow for the connection of various I/O devices 1414 (e.g., keyboards, displays, mouse devices, pen input, etc.) to the computer system 1400.

Computer system 1400 may implement the techniques described herein using customized hard-wired logic, one or more ASICs or FPGAs, firmware, and/or program logic which in combination with the computer system causes or programs computer system 1400 to be a special-purpose machine. According to one implementation, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative implementations, hard-wired circuitry may be used in place of or in combination with software instructions.

Storage media associated with the described system may include any non-transitory media that store data and/or instructions that cause a machine to operate in a specific fashion. Such storage media may comprise non-volatile media and/or volatile media. Non-volatile media includes, for example, optical or magnetic disks, such as storage device 1410. Volatile media includes dynamic memory, such as main memory 1406. Common forms of storage media include, for example, a hard disk, solid state drive, optical data storage medium, a random-access memory (RAM), a programmable read-only memory (PROM), and erasable programmable read-only memory (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire, and fiber optics, including the wires that comprise bus 1402. Transmission media can also take the form of acoustic or light waves, such as those generated during radio-wave and infrared data communications.

Various forms of media may be involved in carrying one or more sequences of one or more instructions to processor 1404 for execution. For example, the instructions may initially be carried storage medium of a remote computer. The remote computer can load the instructions into its dynamic memory and send the instructions over a network. Bus 1402 carries the data to main memory 1406, from which processor 1404 retrieves and executes the instructions. The instructions received by main memory 1406 may optionally be stored on storage device 1410 either before or after execution by processor 1404.

In one or more implementations, computer system 1400 also includes a network interface 1416 coupled to bus 1402. This may enable the described interactive panel to connect to an external local device (such as a mobile device or personal computer) and/or to one or more remote servers that may support various operations of the described system. Network interface 1416 provides a two-way data communication coupling to a network link 1418 that is connected to a local network 1420. For example, network interface 1416 may include a local area network (LAN) interface to provide a data communication connection to a compatible LAN. Wireless links may also be implemented. In implementations, network interface 1416 sends and/or receives electrical, electromagnetic, and/or optical signals that carry digital data streams representing various types of information. In one or more implementations the network interface 1416 may be used to load configuration parameters and/or to update firmware associated with one or more controllers or microcontrollers deployed by the system.

Network link 1418 typically provides data communication through one or more networks to other data devices. For example, network link 1418 may provide a connection through local network 1422 to a host computer 1424 or to data equipment operated by an Internet Service Provider (ISP) 1426. ISP 1426 in turn provides data communication services through the worldwide packet data communication network (e.g., the Internet) 1428. Local network 1422 and/or Internet 1428 use electrical, electromagnetic, and/or optical signals that carry digital data streams. The signals through various networks and the signals on network link 1418 and through network interface 1416, which carry the digital data to and from computer system 1400, are example forms of transmission media.

Computer system 1400 can send messages and receive data, including program code, through the network(s), network link 1418 and network interface 1416. In the Internet example, a server 1430 might transmit a requested code for an application program through Internet 1428, ISP 1426, local network 1422 and network interface 1416. The received code may be executed by processor 1404 as it is received, and/or stored in storage device 1410, or other non-volatile storage for later execution.

### 6. Miscellaneous; Extensions

Some portions of this description describe the embodiments in terms of algorithms and symbolic representations of operations on information, or as modules for executing these operations. Embodiments may also include methods in which steps may be performed in different order than in the example embodiments described and/or illustrated in the figures. Any of the methods described herein may be implemented as a computer program comprising instructions stored in a tangible non-transitory computer readable storage medium. These instructions may be executed by one or more processors to carry out the functions described.

Embodiments may also relate to an apparatus for performing the operations herein. This apparatus may be specially constructed for the required purposes, and/or it may comprise a general-purpose computing device selectively activated or reconfigured by a computer program stored in the computer. Furthermore, any computing systems referred to in the specification may include a single processor or may include architectures employing multiple processor designs for increased computing capability. Examples of hardware that may be utilized in executing the described operations may include a general purpose processor (CPU), a graphics processing unit (GPU), a neural processing unit (NPU), a field-programmable gate array (FPGA), an application-specific integrated circuit (ASIC), a microcontroller, or other hardware or combination thereof.

In embodiments where the described device is network-enabled, the device may connect to one or more local devices that executes a user application (such as a mobile device or personal computer), and/or may connect directly or indirectly to one or more remote servers via a network. Operations supporting the connected devices or servers may utilize on-site computing or storage systems, cloud computing or storage systems, or a combination thereof and may be implemented utilizing local or cloud-based servers, which may include physical or virtual machines, containers, or a combination thereof. Cloud-based servers may include private cloud systems, public cloud systems, hybrid public/private cloud systems, or a combination thereof.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Persons skilled in the relevant art can appreciate that many modifications and variations are possible considering the above disclosure. Accordingly, the disclosure of the embodiments is intended to be illustrative, but not limiting, of the scope of the patent rights, which is set forth in the following claims.

What is claimed is:

1. An optical sensor apparatus, comprising:
a first cell comprising:
a first optical diffuser;
an emitter configured to emit, through the first optical diffuser, a modulated invisible light signal; and
a first controller configured to cause the emitter to emit the modulated invisible light signal according to a temporal modulation pattern;
a second cell comprising:
a second optical diffuser;
a detector configured to receive, through the second optical diffuser, a reflected component of the modulated invisible light signal; and
a second controller configured to:
perform an assessment of a presence of an object at least in part by identifying the reflected component as corresponding to the modulated invisible light signal by correlating the reflected component with the temporal modulation pattern; and
selectively generate an output signal based on the assessment.

2. The apparatus of claim 1, wherein:
the temporal modulation pattern comprises at least one of: a pseudo-random sequence or an encoded modulation sequence; and
the first controller is configured to cause the emitter to emit the modulated invisible light signal using at least one of duty cycling, phase-shifting, or frequency modulation.

3. The apparatus of claim 1, wherein:
the second controller is configured to distinguish the reflected component from ambient light by comparing a first detected signal to a second detected signal;
the first detected signal is associated with the emitter being active; and
the second detected signal is associated with the emitter being inactive.

4. The apparatus of claim 1, wherein:
the first controller and the second controller are synchronized to a common timing according to a synchronization signal that temporally aligns detection of the reflected component with emission of the modulated invisible light signal.

5. The apparatus of claim 1, wherein:
the reflected component detected by the second controller corresponds to light emitted by the emitter of the first cell and reflected by an object located externally to both the first cell and the second cell.

6. The apparatus of claim 1, wherein:
the first cell and the second cell are arranged within a panel comprising at least one additional cell, the at least one additional cell comprising at least one additional emitter, at least one additional detector, at least one additional optical diffuser, and at least one additional controller;
the first controller is configured to operate a first subset of cells of the panel, including the first cell;
the second controller is configured to operate a second subset of cells of the panel, including the second cell;
the at least one additional controller is configured to operate at least one additional subset of cells of the panel, including the at least one additional cell; and
the first cell, the second cell, and the at least one additional cell are arranged planarly across a face of the panel.

7. The apparatus of claim 1, wherein:
the second controller is configured to determine a proximity of the object by applying calibration data and a first weighting based on a geometry of at least one of the first cell or the second cell.

8. The apparatus of claim 7, further comprising:
an additional cell neighboring the second cell, wherein:
the first cell neighbors the second cell;
the first weighting is determined based at least on a length of a first edge of the second cell that neighbors a second edge of the first cell;
the second controller is configured to determine the proximity of the object by applying the calibration data and a second weighting; and
the second weighting is determined based at least on a length of a third edge of the second cell that neighbors a fourth edge of the additional cell.

9. The apparatus of claim 1, wherein:
the first controller is configured to activate a group of emitters, including the emitter, according to a defined sequence, to result in a group of active emitters;
the second controller is configured to detect reflected light corresponding to the group of active emitters; and
the second controller is configured to distinguish a plurality of reflected components originating from a plurality of different emitters by correlating a plurality of received signals with a plurality of respective temporal modulation patterns associated with the plurality of different emitters.

10. The apparatus of claim 1, further comprising:
at least one additional cell;
wherein the first cell, the second cell, and the at least one additional cell are communicatively coupled in a serial communication path; and
wherein a last cell of the serial communication path is configured to emit a synchronization signal to one or more other cells of the serial communication path.

11. The apparatus of claim 1, further comprising:
a main controller configured to:
initiate a calibration sequence of a plurality of cells of the apparatus by performing a plurality of optical detections by the plurality of cells in a predefined detection sequence;
measure a plurality of values corresponding to a respective plurality of amounts of a respective plurality of reflected components received by the plurality of cells during the predefined detection sequence; and
respectively define a plurality of calibration values for the plurality of cells based on the plurality of values,
wherein the plurality of cells includes the first cell and the second cell; and
wherein the plurality of optical detections includes a first optical detection by the first cell and a second optical detection by the second cell.

12. The apparatus of claim 1, wherein:
at least one of the first controller or the second controller are configured to:
detect a proximity of an object to at least one of the first cell or the second cell based on a calibration value; and
responsive to determining that the proximity of the object satisfies a proximity criteria, generate a control signal causing a light emitting diode of the apparatus to emit visible light.

13. The apparatus of claim 1, wherein:
the second controller is configured to generate a matrix comprising at least a first value and a second value;
the first value quantifies a first detected reflected component of the modulated invisible light signal emitted by the first cell and detected by the second cell;
the second value quantifies a second detected reflected component of the modulated invisible light signal emitted by the first cell and detected by an additional cell; and
the second controller is configured to determine a proximity of the object based on the first value and the second value.

14. The apparatus of claim 1, wherein:
the first controller, the second controller, and a last controller of a last cell are in mutual serial communication in a daisy-chain configuration;
the last cell controller is downstream from the first controller and the second controller; and
the last cell controller is configured to assert a resynchronization signal to the first controller and the second controller between a first group illumination operation of a scan operation and a second group illumination of the scan operation.

15. The apparatus of claim 1, wherein:
the second controller is configured to determine the reflected component by correlating the reflected component with the temporal modulation pattern, such that detection of the reflected component is based on a correlation between the temporal modulation pattern and a received signal.

16. The apparatus of claim 1, wherein:
the second controller is configured to compensate for a cell topology of at least the first cell and the second cell when determining a proximity of the object by applying at least one of a per-cell weight, a neighbor weight, or an adjusted calibration table value to compensate for spatial dispersion of the modulated invisible light signal.

17. The apparatus of claim 1, wherein:
the second controller is configured to determine a spatial characteristic of the object based on reflected components detected from a plurality of cells including the first cell; and
the spatial characteristic comprises at least one of an estimated position, a contour, or an overlapping extent of the object relative to the plurality of cells.

18. The apparatus of claim 1, wherein:
the first cell is assigned to a first spatial group of a plurality of cells of a panel;
the second cell is assigned to a second spatial group of the plurality of cells of the panel; and
the first spatial group and the second spatial group are predefined based on a neighborhood topology of the panel; and
the neighborhood topology defines adjacency relationships between cells of the plurality of cells such that a particular cell is associated with a set of neighboring cells according to relative spatial proximity.

19. An interactive display system, comprising:
a frame;
a power supply;
an interface comprising at least one of: a power toggle, a brightness control, or an operation mode selector; and
a display panel supported by the frame and operatively coupled to the power supply and to the interface, the display panel comprising:
a first cell comprising:
a first optical diffuser;
an emitter configured to emit, through the first optical diffuser, a modulated invisible light signal; and
a first controller configured to cause the emitter to emit the modulated invisible light signal according to a temporal modulation pattern;
a second cell comprising:
a second optical diffuser;
a detector configured to receive, through the second optical diffuser, a reflected component of the modulated invisible light signal; and
a second controller configured to:
perform an assessment of a presence of an object at least in part by identifying the reflected component as corresponding to the modulated invisible light signal by correlating the reflected component with the temporal modulation pattern; and
selectively generate an output signal based on the assessment.

20. A method for optically sensing a reflected component of invisible light, comprising:
causing an emitter to emit a modulated invisible light signal according to a temporal modulation pattern;
emitting, by the emitter, through a first optical diffuser, the modulated invisible light signal;
receiving, by a detector of a second cell, through a second optical diffuser, a reflected component of the modulated invisible light signal;
performing an assessment of a presence of an object at least in part by identifying the reflected component as corresponding to the modulated invisible light signal by correlating the reflected component with the temporal modulation pattern; and
selectively generating an output signal based on the assessment.
